(19) United States
(12) Patent Application Publication
(10) Pub. No.: US 2004/0070782 A1
(43) Pub. Date: Apr. 15, 2004

(54) Image forming apparatus, stored document printing method and stored document printing system

(76) Inventor: Sachiko Mihira, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/453,686

(22) Filed: Jun. 4, 2003

(30) Foreign Application Priority Data
Jun. 5, 2002 (JP) 2002-164407
Jun. 5, 2002 (JP) 2002-164408
Jul. 24, 2002 (JP) 2002-215542
Jun. 3, 2003 (JP) 2003-158420
Jun. 3, 2003 (JP) 2003-158421
Jun. 3, 2003 (JP) 2003-158422

(51) Int. Cl. G06K 1/00; G06F 15/00

(52) U.S. Cl. 358/1.14; 358/1.16

(57) ABSTRACT

A document management service receives a certification information acquisition request for a stored document stored in the document storage from another apparatus via a network, and provides certification information in response to the certification information acquisition request. A printing service receives a stored document printing request from the other apparatus with a utilization of the certification information, and printing out a stored document in response to the certification information.

### BACKGROUND OF THE INVENTION

1. Field of the Invention

The present invention relates to an image forming apparatus, a stored document printing method, and a stored document printing system, especially, to an image forming apparatus, a stored document printing method, and a stored document printing system for printing out a stored document according to an instruction from an external network apparatus or another image forming apparatus.

2. The Description of the Related Art

In recent years, an image forming apparatus which has functions of respective apparatuses, such as a printer, a copier, a facsimile machine, a scanner, and so forth, within a common housing has come to be known, which is referred to as a composite machine, hereinafter. Such a composite machine is provided with many types of software respectively corresponding to the printer, copier, facsimile machine, scanner, and so forth, and thus operates as the printer, copier, facsimile machine, scanner and so forth, by selectively activating respective application software, together with a display device, a printing device, an image pick-up device, etc. also enclosed within the common housing. Japanese laid-open patent application No. 2002-84383, for example, discloses such a type of composite machine.

Such a composite machine stores a document file, for example, in a document management database (referred to as a document management DB, hereinafter). The composite machine is connected with a network apparatus, another composite machine, etc. through a communication network, and, thus, the composite machine distributes or delivers the stored document stored in the document management DB, using a distribution/delivery function. Moreover, the composite machine prints out the stored document stored in the document management DB using a printing function. In addition, for the purpose of protecting the security of various data, the composite machine sets a password or so on the stored document stored in the document management DB in many cases.

For example, for downloading such a stored document from another composite machine, a network apparatus transmits a password certifying a usage right on the relevant document together with a document ID for identifying the document. Then, after the relevant composite machine performs a password authentication which then results in success of the authentication, it reads out the stored document corresponding to the document ID from its own document management DB, and supplies the stored document to the network apparatus.

In another example, for printing out a stored document from a composite machine, a network apparatus transmits to the composite machine a password certifying a usage right on the stored document as well as a document ID for identifying the relevant document. Then, after the relevant composite machine performs a password authentication which then results in success of the authentication, it reads out the stored document corresponding to the document ID from its own document management DB, and prints out the stored document.

In another way, when printing out a stored document from a composite machine, a network apparatus transmits to the composite machine a password certifying a usage right on the stored document as well as a document ID for identifying the desired stored document. Then, after this composite machine performs a password authentication which results in a success in the authentication, it reads out the stored document corresponding to the document ID from its own document management DB, and transmits it to the network apparatus once. After that, the network apparatus sends back this document file to the composite machine in which the document is printed out.

Thus, a network apparatus sends a downloading instruction for a stored document, or a printing instruction for a stored document to a composite machine connected therewith through a communication network.

Such a composite machine thus receives various processing instructions for stored documents such as a transmission instruction for a stored document, a printing instruction from a network apparatus or another composite machine. For this reason, the composite machine has various processes of user services according to these various processing instructions. Then, when a password is set on a stored document as mentioned above for the purpose of security protection, a function of password authentication should be executed for every process of user service according to each of various processing instructions for the same stored document. Thereby, the system/operation may become complicated and/or some troublesomeness may occur to a user in this concern.

Moreover, the composite machine sends out a stored document itself after reading it out from the document management DB to a network apparatus in response to every request, in case the document file is processed by a plurality of processes of user services. At this moment, many resources of the composite machine are used since the relevant document file itself is transfer among these many processes.

Further, when a stored document read out from a document management DB is transmitted between a composite machine and a network apparatus via a network for the purpose of printing out the stored document, a somewhat serious load may be applied onto the network especially in a case where the document has a relatively large data amount.

The present invention aims at offering an image forming apparatus which can print out a stored document, a stored document printing method and a stored document printing system which involves such an image forming apparatus, wherein a serious load is prevented from being applied on a communication network even in case a document file having a relatively large data amount is processed, wasteful usage of resources in the machine/apparatus can be omitted, and an authentication operation to be performed can be effectively simplified.

### SUMMARY OF THE INVENTION

In order to achieve the above-mentioned objects of the invention, an image forming apparatus according to the present invention comprising a hardware resource used for image formation, a program for performing processing concerning image formation, an a document storage for storing a stored document, comprises: a document management service receiving a certification information acquisition request for a stored document stored in the document storage from another apparatus via a network, and providing certification information in response to the certification information acquisition request; and a printing service receiving a stored document printing request from the other apparatus with a utilization of the certification information, and printing out a stored document in response to the certification information.

An image forming apparatus according to another aspect of the present invention comprising a hardware resource used for image formation, a program for performing processing concerning image formation, an a document storage for storing a stored document, comprises: a document management service receiving a certification information acquisition request for a stored document stored in the document storage from another apparatus via a network, and providing session information configured to directly or indirectly indicate a correspondence with certification information in response to the certification information acquisition request; and a printing service receiving a stored document printing request from the other apparatus with a utilization of the session information, and printing out a stored document in response to the certification information with the correspondence directly or indirectly indicated by the session information.

An image forming apparatus according to another aspect of the present invention comprising a hardware resource used for image formation, a program for performing processing concerning image formation, an a document storage for storing a stored document, comprises: a document management service receiving a certification information acquisition request and first session information for a stored document stored in the document storage from another apparatus via a network, and providing certification information in response to the certification information acquisition request; and a printing service receiving a stored document printing request from the other apparatus with a utilization of the certification information and second session information, and printing out a stored document in response to the certification information.

A stored document printing method for an image forming apparatus comprising a hardware resource used for image formation, a program for performing processing concerning image formation, an a document storage for storing a stored document, according to another aspect of the present invention, comprises the steps of: a) receiving a certification information acquisition request for a stored document stored in the document storage from another apparatus via a network, and providing session information configured to directly or indirectly indicate a correspondence with certification information in response to the certification information acquisition request; and b) receiving a stored document printing request from the other apparatus with a utilization of the session information, and printing out a stored document in response to the certification information with the correspondence directly or indirectly indicated by the session information.

A stored document printing method for an image forming apparatus comprising a hardware resource used for image formation, a program for performing processing concerning image formation, an a document storage for storing a stored document, according to another aspect of the present invention, comprises the steps of: a) receiving a certification information acquisition request and first session information for a stored document stored in the document storage from another apparatus via a network, and providing certification information in response to the certification information acquisition request; and b) receiving a stored document printing request from the other apparatus with a utilization of the certification information and second session information, and printing out a stored document in response to the certification information.

A stored document printing system according to another aspect of the present invention uses at least one other apparatus, and an image forming apparatus which is connected with the other apparatus via a network, and printing out a stored document stored in a document storage of the image forming apparatus, wherein the image forming apparatus comprises: a document management service receiving a certification information acquisition request for a stored document stored in the document storage from another apparatus via a network, and providing certification information in response to the certification information acquisition request; and a printing service receiving a stored document printing request from the other apparatus with a utilization of the certification information, and printing out a stored document in response to the certification information.

A stored document printing system according to another aspect of the present invention uses at least one other apparatus, and an image forming apparatus which is connected with the other apparatus via a network, and printing out a stored document stored in a document storage of the image forming apparatus, wherein the image forming apparatus comprises: a document management service receiving a certification information acquisition request for a stored document stored in the document storage from another apparatus via a network, and providing session information configured to directly or indirectly indicate a correspondence with certification information in response to the certification information acquisition request; and a printing service receiving a stored document printing request from the other apparatus with a utilization of the session information, and printing out a stored document in response to the certification information with the correspondence directly or indirectly indicated by the session information.

A stored document printing system according to another aspect of the present invention uses at least one other apparatus, and an image forming apparatus which is connected with the other apparatus via a network, and printing out a stored document stored in a document storage of the image forming apparatus, wherein the image forming apparatus comprises: a document management service receiving a certification information acquisition request and first session information for a stored document stored in the document storage from another apparatus via a network, and providing certification information in response to the certification information acquisition request; and a printing service receiving a stored document printing request from the other apparatus with a utilization of the certification information and second session information, and printing out a stored document in response to the certification information.

According to the present invention described above, the document management service provides the certification in formation according to the certification information acquisition request after the document management service performs authentication check on the stored document. And then, the printing service receivers the stored document printing request from the other apparatus and, thus, the authentication function on the stored document can be shared among these respective services.

Furthermore, as the certification information according to the certification information acquisition request is transferred between the other apparatus and the document management service or the printing service, printing of the stored document is achieved within a minimum transfer operation of the stored document itself thereamong. Accordingly, the resources of image forming apparatus can be efficiently used, or these resources can be avoided from being used wastefully, and also, the communication network can be prevented from being applied with a heavy load which would occur otherwise due to such a wasteful document data transfer.

An image forming apparatus according to another aspect of the present invention comprising a hardware resource used for image formation, a program for performing processing concerning image formation, an a document storage for storing a stored document, comprises: a network service receiving a stored document printing request for a stored document stored in the document storage from another apparatus via a network; a document management service creating certification information in response to the stored document printing service, and transmitting it to the network service; and a printing service receiving the certification information from the network service, acquiring the stored document in response to the certification information, and printing the same.

An image forming apparatus according to another aspect of the present invention comprising a hardware resource used for image formation, a program for performing processing concerning image formation, an a document storage for storing a stored document, comprises: a network service receiving a stored document printing request for a stored document stored in the document storage from another apparatus via a network; a session object managing information of a session established with the other apparatus and the stored document printing request received from the other apparatus in a manner of directly or indirectly indicating a correspondence therebetween; a document management service creating certification information in response to the stored document printing service, and transmitting it to the network service; and a printing service receiving the certification information from the network service, acquiring a stored document in response to the certification information, and printing the same.

A stored document printing method for an image forming apparatus comprising a hardware resource used for image formation, a program for performing processing concerning image formation, an a document storage for storing a stored document, according to another aspect of the present invention, comprises the steps of: a) receiving a stored document printing request for a stored document stored in the document storage from another apparatus via a network; b) creating certification information in response to the stored document printing service; and c) a printing service receiving the certification information from a network service, acquiring the stored document according to the certification information, and printing the same.

A stored document printing method for an image forming apparatus comprising a hardware resource used for image formation, a program for performing processing concerning image formation, an a document storage for storing a stored document, according to another aspect of the present invention, comprises the steps of: a) receiving a stored document printing request for a stored document stored in the document storage from another apparatus via a network; b) managing information of a session established with the other apparatus and the stored document printing request received from the other apparatus in a manner of directly or indirectly indicating a correspondence therebetween; c) creating certification information in response to the stored document printing request; and d) a printing service receiving the certification information from a network service, acquiring a stored document in response to the certification information, and printing the same.

A stored document printing system according to another aspect of the present invention uses at least one other apparatus, and an image forming apparatus connected with the other apparatus via a network, for printing out a stored document stored in a document storage of the image forming apparatus, wherein the image forming apparatus comprises: a network service receiving a stored document printing request for a stored document stored in the document storage from another apparatus via a network; a document management service creating certification information in response to the stored document printing service, and transmitting it to the network service; and a printing service receiving the certification information from the network service, acquiring the stored document in response to the certification information, and printing the same.

A stored document printing system according to another aspect of the present invention uses at least one other apparatus, and an image forming apparatus connected with the other apparatus via a network, for printing out a stored document stored in a document storage of the image forming apparatus, wherein the image forming apparatus comprises: a network service receiving a stored document printing request for a stored document stored in the document storage from another apparatus via a network; a session object managing information of a session established with the other apparatus and the stored document printing request received from the other apparatus in a manner of directly or indirectly indicating a correspondence therebetween; a document management service creating certification information in response to the stored document printing service, and transmitting it to the network service; and a printing service receiving the certification information from the network service, acquiring a stored document in response to the certification information, and printing the same.

According to the present invention described above, the document management service creates the certification information according to the certification information acquisition request made by the other apparatus, after the document management service performs authentication check on the stored document. And then, the network service acquires from the document management service the certification information according to the stored document printing request, the printing service acquires from networks service the certification information according to the stored document acquisition request, and thus, the authentication function on the stored document can be shared among these services.

Furthermore, as the certification information according to the certification information acquisition request is transferred among the network service, the document management service and the printing service, printing of the stored document is achieved within a minimum transfer operation of the stored document itself among these user services. Accordingly, the resources of image forming apparatus can be efficiently used.

An image forming apparatus according to another aspect of the present invention comprising a hardware resource used for image formation, a program for performing processing concerning image formation, an a document storage for storing a stored document, comprises: a document management service receiving a certification information acquisition request for a stored document stored in the document storage from one apparatus via a network, and providing certification information in response to the certification information acquisition request to the one apparatus; as well as receiving from another apparatus connected via the network a stored document acquisition request with a utilization of the certification information, and transmitting a stored document in response to the certification information to the other apparatus.

An image forming apparatus according to another aspect of the present invention comprising a hardware resource used for image formation, a program for performing processing concerning image formation, an a document storage for storing a stored document, comprises: a document output service receiving certification information for a stored document stored in another apparatus, from one apparatus, both connected via the network, and transmitting a stored document acquisition request with a utilization of the certification information to the other apparatus, wherein: upon receiving a stored document in response to the certification information from the other apparatus, the document output service outputting the stored document.

An image forming apparatus according to another aspect of the present invention comprising a hardware resource used for image formation, a program for performing processing concerning image formation, an a document storage for storing a stored document, comprises: a document management service receiving from one apparatus connected via a network a certification information acquisition request for a stored document stored in the document storage, and transmitting to the one apparatus first certification information certifying a usage right on the document management service and second certification information certifying a usage right on a stored document in response to the certification information acquisition request; as well as receiving from another apparatus connected via the network a stored document acquisition request with a utilization of the first certification information and the second certification information, acquiring the stored document in response to the second certification information from the document storage, and transmitting it to the other apparatus.

An image forming apparatus according to another aspect of the present invention comprising a hardware resource used for image formation, a program for performing processing concerning image formation, an a document storage for storing a stored document, comprises: a document output service receiving from one apparatus connected via a network first certification information certifying a usage right on a document management service of another apparatus, and second certification information certifying a usage right on the stored document, and transmitting a stored document acquisition request with a utilization of the first and second certification information to the other apparatus, while receiving a stored document according to the second certification information from the document management service of the other apparatus, and outputting the stored document.

An image forming apparatus according to another aspect of the present invention comprising a hardware resource used for image formation, a program for performing processing concerning image formation, an a document storage for storing a stored document, comprises: a document management service receiving from one apparatus connected via a network a certification information acquisition request for a stored document stored in the document storage, and transmitting to the one apparatus first certification information certifying a usage right on the document management service and second certification information certifying a usage right on a stored document in response to the certification information acquisition request; while receiving from another apparatus connected via the network a stored document acquisition request with a utilization of the second certification information and third certification information providing the usage right on the document management service, acquiring the stored document according to the second certification information from the document storage, and transmitting the same to the other apparatus.

An image forming apparatus according to another aspect of the present invention comprising a hardware resource used for image formation, a program for performing processing concerning image formation, an a document storage for storing a stored document, comprises: a document management service receiving from one apparatus connected via a network a first certification information certifying a usage right on a document output service and second certification information certifying a usage right on the stored document, and transmitting to another apparatus a stored document acquisition request with a utilization of the second certification information and third certification information certifying a usage right on a document management service of the other apparatus, while receiving the stored document according to the second certification information from the document management service of the other apparatus, and outputting the stored document.

According to the present invention described above, the document management service transmits the certification information for the stored document stored in the document storage, to the other apparatus. Then, the document output service of the other apparatus outputs the stored document by using the identification information for the stored document. Thus, the authentication function on the stored document can be shared.

Furthermore, by using the certification information, it becomes unnecessary to transfer the stored document itself among the plurality of image forming apparatuses wastefully. Thus, the network load can be effectively reduced, and also, the load on the resources of the machines can also be reduced effectively

### BRIEF DESCRIPTION OF THE DRAWINGS

Other objects and further features of the present invention will become more apparent from the following detailed description when read in conjunction with the following accompanying drawings:

FIG. 1 shows a configuration diagram of a composite machine according to each of first through eighth embodiments of the present invention;

FIG. 2 shows a hardware configuration diagram of the composite machine shown in FIG. 1;

FIG. 3 shows a functional configuration diagram of the composite machine for illustrating a stored document printing method according to the first embodiment of the present invention;

FIGS. 4A and 4B illustrate a ticket applicable to each of the respective embodiments of the present invention;

FIG. 5 shows an event flow chart of a stored document printing processing performed by a printing service and an ECS shown in FIG. 1 according to the first embodiment of the present invention;

FIG. 6 shows a functional configuration diagram of the composite machine for illustrating a stored document printing method according to the second embodiment of the present invention;

FIG. 7 shows a functional configuration diagram of the composite machine for illustrating a stored document printing method according to the third embodiment of the present invention;

FIG. 8 shows a functional configuration diagram of the composite machine for illustrating a stored document printing method according to the fourth embodiment of the present invention;

FIG. 9 shows an event flow chart of a stored document printing processing performed by a printing service and an ECS shown in FIG. 1 according to the fourth embodiment of the present invention;

FIG. 10 shows a functional configuration diagram of the composite machine for illustrating a stored document printing method according to the fifth embodiment of the present invention;

FIG. 11 illustrates a configuration of a Web page service shown in FIG. 10;

FIG. 12 shows a functional configuration diagram of the composite machines for illustrating a stored document printing method according to the sixth embodiment of the present invention;

FIG. 13 shows an event flow chart of a stored document printing processing performed by a printing service and an ECS shown in FIG. 1 according to the sixth embodiment of the present invention;

FIG. 14 shows a functional configuration diagram of the composite machines for illustrating a stored document printing method according to the seventh embodiment of the present invention;

FIG. 15 shows a functional configuration diagram of the composite machines for illustrating a stored document printing method according to the eighth embodiment of the present invention; and

FIGS. 16A through 16C illustrate pages displayed on an operation panel shown in FIG. 2.

### DESCRIPTION OF THE PREFERRED EMBODIMENTS

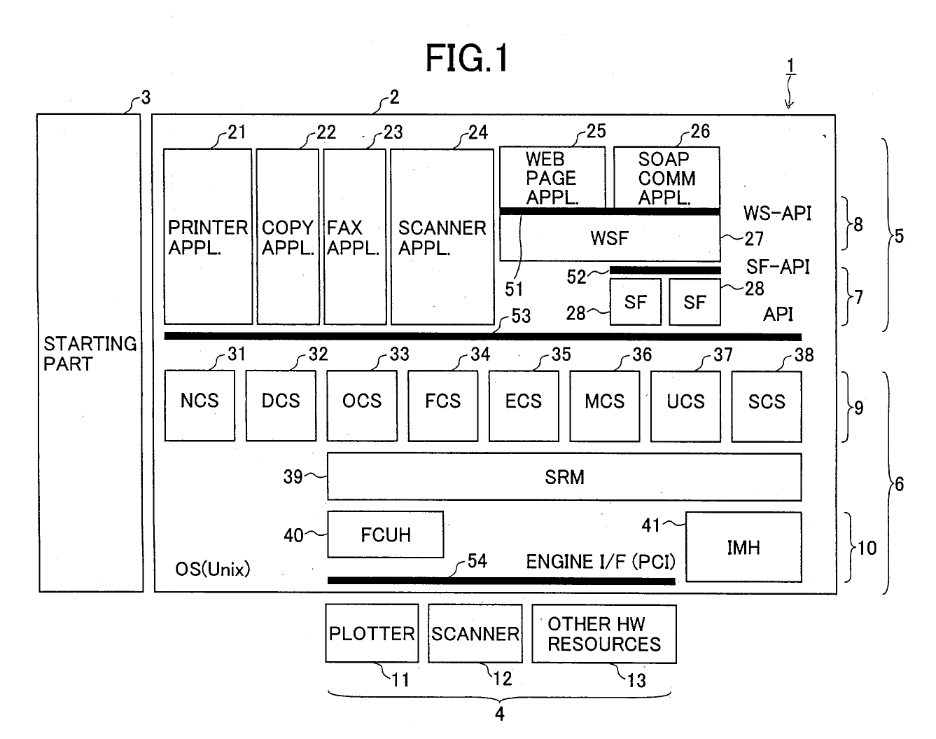

Embodiments of the present invention will now be described with reference to figures. FIG. 1 shows a configuration of a composite machine in each if the first through eighth embodiments of the present invention. The composite machine 1 includes a software group 2, a composite machine starting part 3, and hardware resources 4.

The composite machine starting part 3 is a program first executed at a time of start of a power supply in the composite machine 1, and starts an application layer 5 and a platform 6. For example, the composite machine starting part 3 reads out programs of the application layer 5 and platform 6 from a hard disk drive (referred to as an HDD, hereinafter) etc. therein, transmits each program which is thus read out to a memory area, and starts it. The hardware resources 4 include a plotter 11, a scanner 12, and other hardware resources 13 such as a facsimile device, and so forth.

The software group 2 includes the application layer 5 and platform 6 which are started on an operating system (referred to as an OS, hereinafter), such as a UNIX (registered trademark). The application layer 5 includes programs for performing processing unique to a respective user service concerning image formation such as those conventionally performed by a printer, a copier, facsimile machine, a scanner, etc.

The application layer 5 includes various software applications (programs) such as a printer application 21 for a printing function, a copy application 22 for a copying function, a facsimile application 23 for a facsimile function, a scanner application 24 for a scanning function, a WEB page application 25 for a WEB page function, a SOAP communication application 26 for a simple object access protocol (referred to as SOAP, hereinafter) communication function, a sharing function layer 7 including at least one shared function, and a wrapping layer 8 having a WEB service function (referred to as a WSF, hereinafter) 27 provided between the WEB page application 25, the SOAP communication application 26 and SFs 28.

The WSF 27 has a an application program interface 51 (refereed to as an API, hereinafter) by which, through a function previously defined, processing requests can be received from the WEB page application 25 and SOAP communication application 26. Further, the SF 28 has an API 52 by which, through a function previously defined, processing requests can be received from the WSF 27.

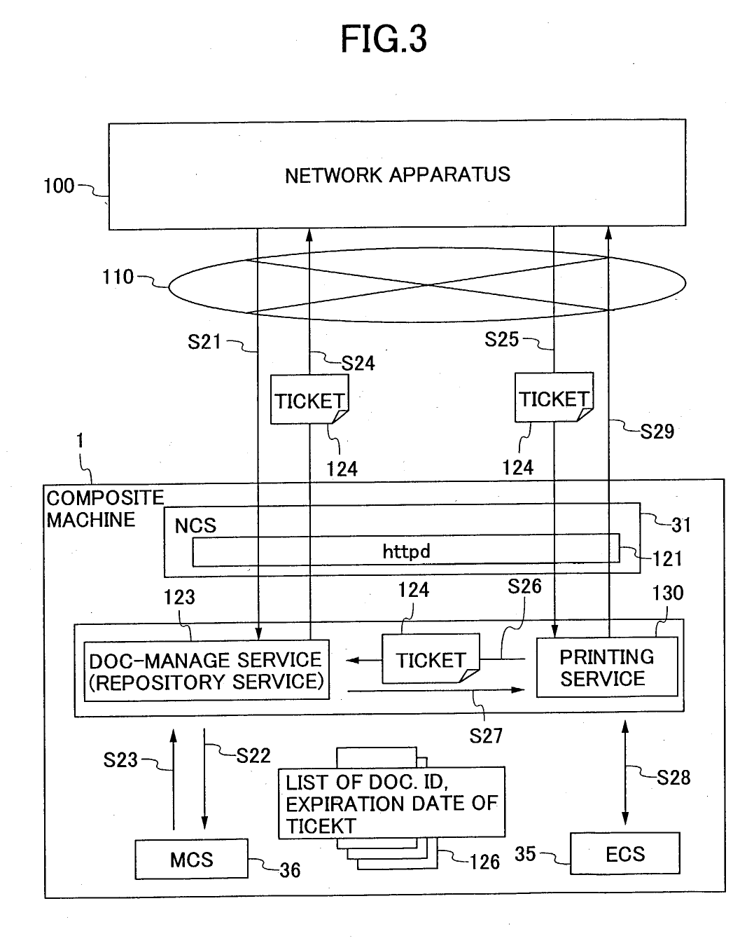

When receiving processing requests through the API 51 from the WEB page application 25 and SOAP communication application 26, the WSF27 selects a respective one of the SFs 28 according to the processing requests. Then, the WSF 27 sends the processing requests thus received to the thus-selected SFs 28 via the API 52. When thus receiving the processing requests via the API 52, the SFs 28 execute processing in response to these requests. , For example, the composite machine 1 shown in FIG. 1 includes the two SFs 28, and one thereof acts as a document management service 123 or so, which will be described later with reference to FIG. 3 or so, and the other of the SFs 28 acts as a printing service 130 or so, which will also be described later with reference to FIG. 3 or so.

The platform 6 includes, as software programs, a control service layer 9 which interprets processing requests sent from the application layer 5, and creates requests for acquiring necessary hardware resources 4; a system resource manager (referred to as an SRM, hereinafter) 39 which performs management on at least one hardware resource 4, and performs arbitration on the acquiring requests sent from the control service layer 9, and a handler layer 10 performing management of the hardware resources 4 in response to the acquisition requests coming from the SRM 39.

The above-mentioned control service layer 9 includes at least one service module (software program or so) such as a network control service (referred to as an NCS) 31, a delivery control service (referred to as a DCS) 32, an operation panel control service (referred to as an OCS) 33, a facsimile control service (referred to as an FCS) 34; an engine control service (referred to as an ECS) 35; a memory control service (referred to as an MCS) 36; a user information control service (referred to as a UCS) 37; a system control service (referred to as an SCS) 38, and so forth.

The platform 40 has an application program interface (referred to as an APT) through which a processing request coming from an application 30 can be properly received through a previously defined function. The OS carries out parallel execution of respective ones of the software programs included in the application layer 5 and the platform 6 regarding them as respective processes.

A process of the NCS 31 provides a service utilizable in common for applications which need network I/O, and acts as an agency for performing distribution/delivery of data received from the network in each type of protocol to a respective application, while performing transmission of data coming from each application to the network.

For example, the NCS 31 controls data communications with the network apparatus connected through the network according to an HTTP (HyperText Transfer Protocol) via an httpd (HyperText Transfer Protocol Daemon).

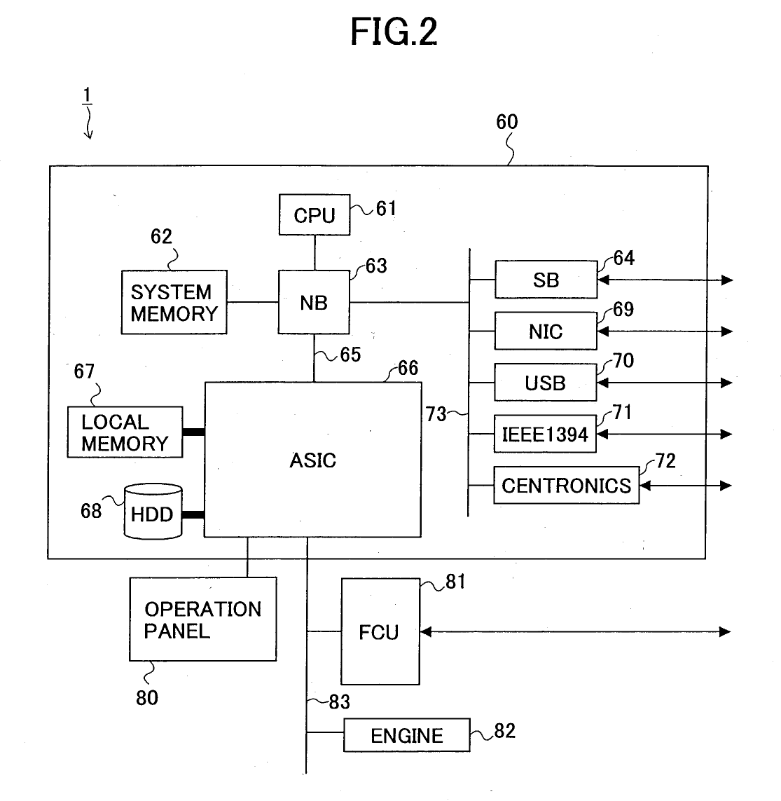

A process of DCS 32 controls delivery of stored documents etc. A process of OCS 33 controls an operation panel 80 shown in FIG. 2 which is used as an information transfer device between an operator or user and the control system in the composite machine 1. A process of the FCS 34 provides an API for performing a facsimile transmission/reception utilizing PSTN or ISDN to/from the application layer 5, registration/reference of various types of facsimile data managed in a memory provided for a backup purpose, a facsimile reading-in operation, facsimile reception and printing-out operation, and so forth.

A process of the ECS 35 is of controlling an engine part 82, such as the plotter 11, the scanner 12, the other hardware resources 13 or so. A process of the MCS 36 is of a memory control such as acquisition/release of an image memory area, a use of an HDD area, compression/decompression of image data, etc. A process of the UCS 37 performs management of user's personal information.

A process of the SCS 38 is of an application management, an operation unit control, a system screen display, an LED display, a hardware resource management, an interruption application control, etc.

A process of the SRM 39 is of performing a control of the system and a management of the hardware resources 4 together with the SCS 38. For example, the SRM 39 performs arbitration and execution control according to acquisition requests coming from higher layers utilizing the hardware resources 4 such as the plotter 11, scanner 12 and so forth

Specifically, the SRM 39 determines whether or not the requested hardware resources 4 are available or whether or not these hardware resources 4 are already used by other requests, and, when they are available, it notifies that the requested hardware resources are available to the upper layers. Furthermore, the SRM 39 receives acquisition requests from the upper layers, performs scheduling thereon for efficiently utilizing the hardware resources 4, and also directly performs requested tasks (for example, paper feeding and image formation with the printer engine, memory acquisition, file creation, and so forth).

The handler layer 10 includes a facsimile control unit handler (referred to as a FCUH) 40 performing management of a facsimile control unit (referred to as an FCU, which will be described later), and an image memory handler (referred to as an IMH) 41 which performs allocation of memory areas for respective processes, and a management of the thus-allocated memory areas. The SRM 39 and FCUH 40 utilize an engine I/F 54 which enables transmission of processing requests toward the hardware resources 4 through a previously defined function, and, thus, actually makes processing requests to the hardware resources 4.

The composite machine 1 can manage, in centralization manner, operations required in common by respective applications in the platform 6. A hardware configuration of the composite machine 1 will now be described.

FIG. 2 shows a hardware configuration of the above-described composite machine according to each of the respective embodiments of the present invention. The composite machine 1 includes a controller 60, which actually performs various control operations in the composite machine 1 described above, the operation panel 80, the FCU 81, and the engine part 82.

The controller 60 includes a CPU 61, a system memory 62, a north bridge (NB) 63, a south bridge (SB) 64, an ASIC 66, a local memory 67, a HDD 68, a network interface card (NIC) 69, a USB device 70, an IEEE 1394 device 71, and a centronics unit 72.

The operation panel 80 is connected to the ASIC 66 of the controller 60. The FCU 81 and engine part 82 are connected to the ASIC 66 of the controller 60 via a PCI bus 83.

In the controller 60, the local memory 67, HDD 68, etc. are connected to the ASIC 66, and the CPU 61 and the ASIC 66 are connected together via the NB 63 of the CPU chip set. In the controller 60, by connecting the CPU 61 and the ASIC 66 via the NB 63, the controller 60 is applicable to a case when the interface of the CPU 61 is not opened to the public. The ASIC 66 and NB 63 are connected via an AGP (Accelerated Graphic Port) 65.

Thus, in order to perform an execution control on one or a plurality of processes provided by the applications 5 and the platform 6 of FIG. 1, a degradation in performance can be avoided by connecting the ASIC 66 and the NB 63 together not via a low-rate PCI bus but via the AGP 65.

The CPU 61 performs a control of the entire composite machine 1. The CPU 61 starts and executes the NCS 31, DCS 32, OCS 33, FCS 34, ECS 35, MCS 36, UCS 37, SCS 38, SRM 39, FCUH 40 and IMH 41 as processes, respectively, on the OS, and, also, starts and executes the printer application 21, copy application 22, facsimile application 23, scanner application 24, Web page application 25, SOAP communication application 26, WSF 27 and SFs 28 included in the application layer 5.

The NB 63 is a bridge connecting the CPU 61, system memory 62, SB 64, ASIC 66, NIC 69, USB device 70, IEEE 1394 device, and centronics unit 72 together.

The SB 64, NIC 69, USB device 70, IEEE 1394 device 71 and centronics unit 72 are connected with the NB 63 via a PCI bus 73. The SB 64 is a bridge connecting the PCI bus 73 with a ROM, peripheral devices and so forth.

The system memory 62 is a memory used as a drawing memory in the composite machine 1. The SB 64 is a bridge connecting the NB 63 with a ROM, the PCI bus and peripheral devices. The local memory 67 is a memory used as a buffer for image copying, a code buffer, or so.

The ASIC 66 is an IC including a hardware device for image processing, and used for an image processing purpose. The HDD 68 is one example of a storage (secondary storage) used for storing image data, storing document data, storing various sorts of programs, storing font data, storing various data concerning forms, or so.

The NIC 69 is an interface device connecting the composite machine 1 with a communication network such as the Internet. The USB device 70, IEEE 1394 device 71 and Centronics unit 72 are interfaces according to the respective interface standards well-known.

The operation panel 80 accepts operator's input operations, and also, acts as a display device for displaying various information for the operator. The FCU (facsimile control unit) 81 has a backup memory. The memory of the FCU 81 is used, for example, for temporarily storing facsimile data received when the power supply to the composite machine 1 is turned off.

With reference to figures, the first through eighth embodiments of the present invention will now be described in sequence. The configurations of the respective embodiments may be achieved by respective software programs, or so. The present invention can be embodied in any form which may include all the functions according to the respective embodiments, or may include only the functions according to any one or any combination of these respective embodiments. Such various forms of embodiments may be included in the present invention.

A stored document printing method performed by the composite machine 1 according to the first embodiment of the present invention will now be described. FIG. 3 shows a functional block diagram of the composite machine for illustrating the stored document printing method according to the first embodiment of the present invention. The functional block diagram shown in FIG. 3 omits illustration of functional parts not particularly relevant to the description of the stored document printing method according to the first embodiment of the present invention.

As shown in FIG. 3, the stored document printing method according to the first embodiment of the present invention is a method for a network apparatus 100, such as a host computer, connected with the composite machine 1 through a communication network 110, such as the Internet, to make the composite machine 1 print out a document file (referred to as a ‘stored document’, hereinafter) stored in the composite machine 1. The network apparatus 100 may be a host computer, as mentioned above, or may be another composite machine identical to the above-mentioned composite machine 1.

The network apparatus 100 performs data communication with a document management service 123 and a printing service 130, both of which are application software installed in the composite machine 1, for example, according to a well-known XML (extensible Markup Language), by using, for example, a communication protocol standard called SOAP (Simple Object Access Protocol) as a data access protocol.

In the stored document printing method, first, the network apparatus 100 receives from the composite machine 1 a list of stored documents and document IDs which is previously stored in the composite machine 1. A user who operates the network apparatus 100, if needed, inputs a password for printing out a stored document after choosing the stored document which the user wishes printing out thereof with reference to the list of stored documents currently displayed on a screen of the network apparatus 100.

Then, in Step S21 shown in FIG. 3, the network apparatus 100 makes an acquisition request for a ticket 124 to the composite machine 1 with transmitting the document ID of the stored document which is thus chosen by the user as well as the relevant password, to the document management service 123 via the communication network 3 and an httpd 121 of the NCS 31. The ticket acquisition request is made preferably with a utilization of the above-mentioned SOAP and XML.

As mentioned above, the document management service 123 is executed by the SF 28 shown in FIG. 1. Alternatively, the document management service 123 may instead be provided in the control service layer 9. In Step S22 following Step S21, the document management service 123 transmits the above-mentioned document ID of the relevant stored document and password received from the network apparatus 100 to the MCS 36, and makes an authentication request on the password. This password authentication request is made using, for example, a predetermined authentication request function ‘int mcsCheckPassword (unsignedint DocId and string password)’ which takes as arguments the document ID of the stored document and the password.

Then, the MCS 36 thus performs a password authentication on the password received from the document management service 123. In Step S23 following Step S22, the MCS 36 transmits a result of the password authentication to the document management service 123. The result of password authentication is then transmitted to the document management service 123 from the MCS 36 as a return value of, in the above-mentioned example, the password authentication request function.

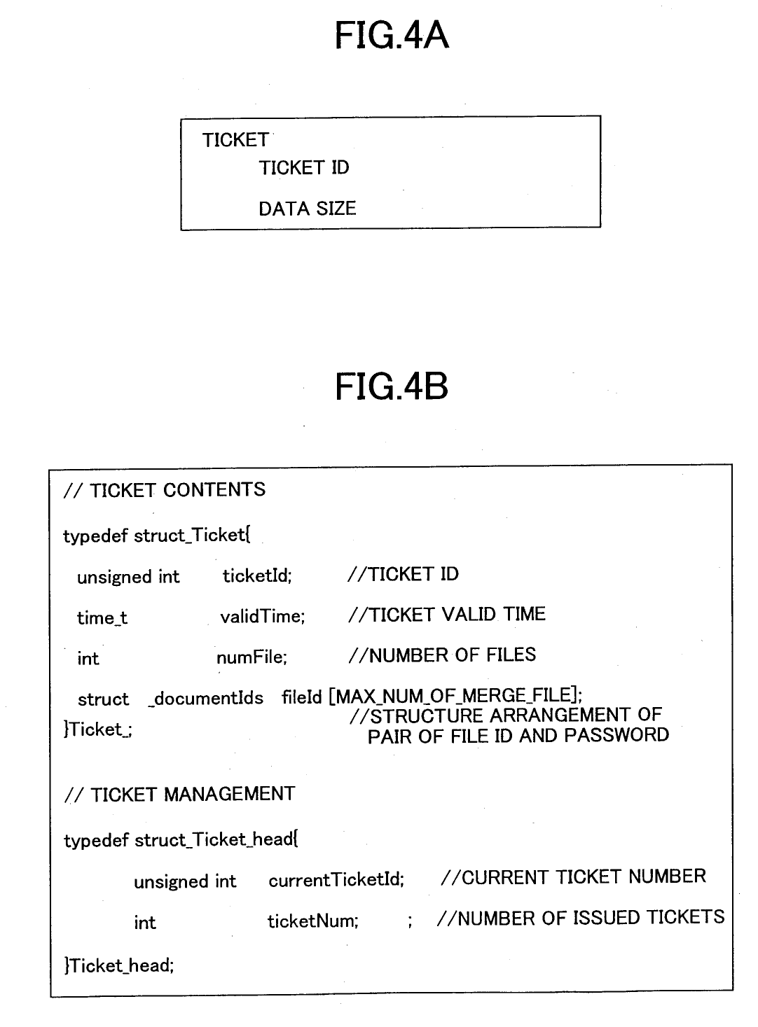

When the password is thus authenticated properly without fail, the document management service 123 creates a ticket, which is a sort of information message, as will be described with reference to FIGS. 4A and 4B, for example. In particular, FIG. 4A shows a structure of the above-mentioned ticket 124 transmitted between the network apparatus 100 and the document management service 123. The ticket 124 has data indicating the ticket ID and the data size of the ticket itself.

FIG. 4B illustrates a table 126 used for checking the ticket 124. The table 126 is data held by the document management service 123. The table 126 includes information indicating the contents of the relevant ticket, and ticket management information. The ticket content information has the ticket ID, expiration date of the ticket, a relevant number of files, and an arrangement of structure containing a file ID which is a document ID and a password as a pair. The ticket management information has the current ticket number and the number of already issued tickets. A mutual correspondence is given between the table 126 and the ticket 124 itself by the ticket ID.

In Step S24 of FIG. 3, the document management service 123 transmits the thus-created ticket 124 to the network apparatus 100 through the httpd 121 of NCS 31 and the network 3. The transmission of the ticket 124 from the document management service 123 to the network apparatus 100 is performed using the SOAP and XML.

In Step S25, the network apparatus 100 transmits the ticket 124 received in Step S24 to the printing service 130 of the composite machine 1, and makes a printing request thereto for the stored document. The printing request for the stored document is made also using SOAP and XML.

The printing service 130 is contained, for example, in the printer application 21. However, the printing service 130 may instead be provided in the control service layer 9 shown in FIG. 1. In Step S26 following Step S25, the printing service 130 transmits the ticket 124 received in Step S25 to the document management service 123, and makes an acquisition request thereto for the document ID corresponding to the ticket. The document ID acquisition request is thus made, for example, using a predetermined document ID acquisition function ‘arrayOfAnyURI getDocumentIdsByThicket (base64Binary ticket)’ with the ticket 12 regarded as an argument of the function.

In Step S27 following Step S26, the document management service 123 acquires the document ID from the table 126 according to the ticket ID contained in the received ticket 124, and transmits the document ID to the printing service 130. The document ID is thus transmitted to the printing service 130 from the document management service 123 as a return value of, in the above-mentioned example, the above-mentioned document ID acquisition function.

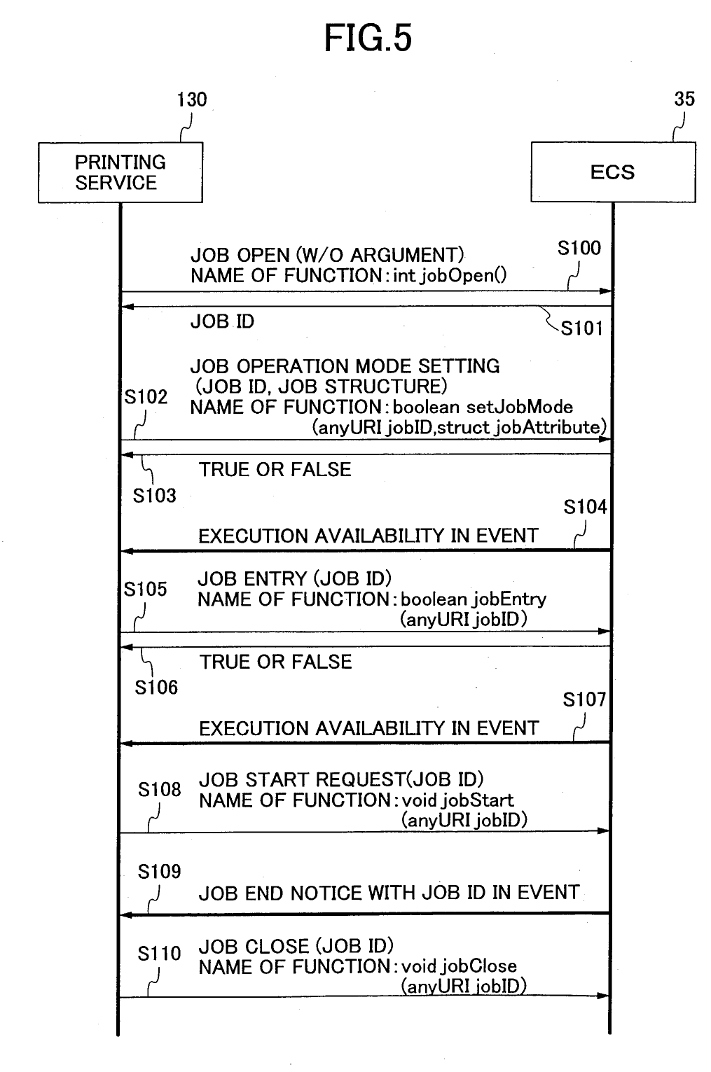

In Step S28 following Step S27, the printing service 130 transmits the document ID received in step S27 to the ECS 35, and performs printing processing for the stored document corresponding to the document ID. With referring to FIG. 5 this stored document printing processing which the printing service 130 and ECS 35 perform will now be described in detail.

FIG. 5 shows an event flow chart of an example of the stored document printing processing which the printing service and ECS perform as mentioned above. In Step S100, the printing service 130 requires job opening of the ECS 35 using a function. In Step S101 following Step S100, the ECS 35 transmits a job ID to the printing service 130 as a return value of the function.

In Step S102 following Step S101, the printing service 130 requires the ECS 35 to set a job operation mode using a function. In Step S103 following Step S102, the ECS 35 transmits information indicating a success or a failure in the setting a job operation mode to the printing service 130 as a return value of the function.

In Step S104 following Step S103, upon receiving the information indicating a success in Step S103, the ECS 35 transmits in an event a notice of whether or not execution can be performed to the printing service 130. If the information indicting a failure is received in Step S103, the current processing is ended without proceeding with the subsequent step. In Step S105 following Step S104, upon receiving the information indicating that the execution can be performed in Step S104, the printing service 130 requires the ECS 35 to make a job entry using a function. If the information not indicting affirmative answer is received in Step S104, the current processing is ended without proceeding with the subsequent step. In Step S106 following Step S105, the ECS 35 transmits information indicating a success or a failure of the job entry to the printing service 130 as a return value of the function.

In Step S107 following Step S106, the ECS 35 transmits a notice of whether or not execution can be performed to the printing service 130 in an event. In Step S108 following Step S107, upon receiving the success information from the ESC 35 in Step S106 and the information indicating that the execution can be performed in Step S107, the printing service 130 requires the ECS 35 to make a job start using a function. Otherwise, the current processing is ended without proceeding with the subsequent steps.

In Step S109 following Step S108, upon an end of the relevant job, the ECS 35 transmits a job ID of the job which has thus ended together with a job end notice in an event to the printing service 130. In Step S110 following Step S109, the printing service 130 requires the ESC 35 to make a job closure using a function.

Through the event flow shown in FIG. 5, the printing service 130 can thus perform printing processing for the stored document corresponding to the document ID received in Step S27. In Step S29 following Step S28, the printing service 130 transmits information indicating a result of the printing processing to the network apparatus 100 through the httpd 121 of the NCS 31 and the network 3. The transmission of information indicating the result of printing processing to the network apparatus 100 from the printing service 130 is thus performed using SOAP and XML.

The network apparatus 100 displays the result of printing processing received from the composite machine 1 on the screen of the network apparatus 100. Thus, the user can print out easily the stored document previously stored in the composite machine 1 by operating the network apparatus 100 in front of the user. In the composite machine 1, printing of the stored document having passed the authentication check process can be performed through the printing service 130 with a utilization of the ticket 124 without specially inputting a password to the printing service 130.

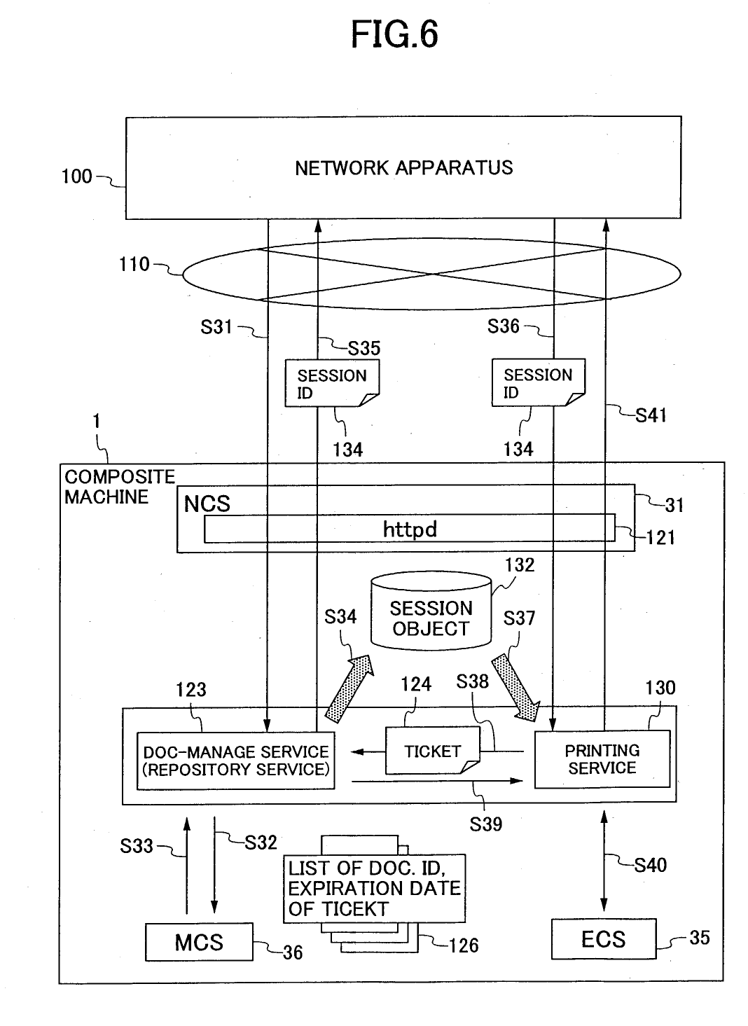

Moreover, in the composite machine 1, by using the ticket 124, actual transmission of document content data itself of the stored document between the composite machine 1 and network apparatus 100 can be omitted, and thereby, a wasteful usage of resources in the machine can be omitted, as well as a heavy load which would otherwise occur on the network can be avoided FIG. 6 shows a functional configuration diagram of the composite machine 1 for illustrating a stored document printing method according to the second embodiment of the present invention. The functional parts not necessary for the description are omitted in illustration in FIG. 6. Since processing of Steps S31 through S33 of FIG. 6 is same as that of Steps 821 through S23 of FIG. 3, duplicated description thereof is omitted.

According to the second embodiment, in Step S34 after the above-mentioned processing of Steps S31 through S33, the document management service 123 makes a predetermined provision enabling an afterwards correspondence of the created ticket 124 with a predetermined session ID 134, and stores the ticket 124 in a session object 132. In Step S35 following Step S34, the document management service 123 transmits the session ID 134 also made a predetermined provision enabling an afterwards correspondence with the session object 132 to the network apparatus 100 through the httpd 121 of the NCS 31 and the network 3. The transmission of the session ID 134 from the document management service 123 to the network apparatus 100 is thus performed using SOAP and XML.

In Step S36, the network apparatus 100 transmits the session ID 134 received in step S35 to the printing service 130 of the composite machine 1, and makes a printing request for the relevant stored document. The printing request for the stored document is thus made using SOAP and XML.

In Step S37, the printing service 130 acquires the ticket 124 from the session object 132 corresponding to the session ID received in Step S36, with reference to the session object 132. At this time, the following process may be executed: The printing service 130 determines whether or not the network apparatus 100 which receives the session ID 134 in Step S35 and the network apparatus 100 which transmits the session ID 134 in Step S36 are same as each other. Then, after determining that these network apparatuses are same as each other, the printing service 130 accepts a printing request for the stored document. Otherwise, i.e., if it is determined that these network apparatuses are not same as each other, a printing request made by one thereof is not accepted.

Since processing of Steps S38 through S41 after thus acquiring the ticket 124 from the session object 132 is the same as the processing of Steps S26 through S29 shown in FIG. 3, duplicated description is omitted.

Thus, according to the above-described second embodiment, on the network 110 between the composite machine 1 and network apparatus 100, security can be protected by eliminating transmission of the ticket 124 itself therebetween, with transmission of the session ID 134 given the predetermined provision for the afterwards correspondence with the session object 132 which holds the ticket 124.

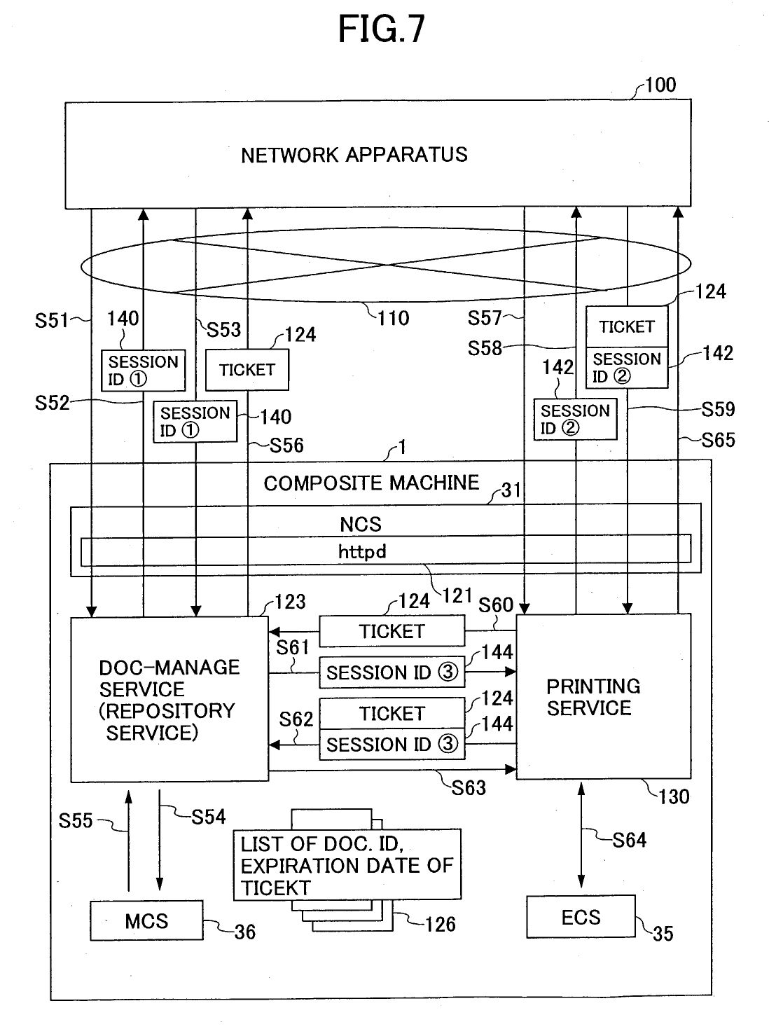

FIG. 7 shows a functional configuration diagram of the composite machine 1 for illustrating a stored document printing method according to the third embodiment of the present invention. The functional parts not needed for the description are omitted in the configuration of FIG. 7 in illustration.

According to the third embodiment, in Step S51, the network apparatus 100 makes a session start request to the document management service 123 of the composite machine 1. In Step S52, the document management service 123 establishes a session with the network apparatus 100, and transmits a session ID \mathring{1} 140 showing the thus—established session to the network apparatus 100.

In Step S53, the network apparatus 100 transmits the thus-received session ID \mathring{1} 140, and an arrangement of the document ID of the stored document chosen by the user and a password, to the document management service 123 of the composite machine 1 for making an acquisition request for a ticket 124. As processing of Steps S54 through S56 is the same as the above-mentioned processing of Steps S22 through S24 of FIG. 3, duplicated description will be omitted.

Then, in Step S57, the network apparatus 100 makes a session start request to the printing service 130 of the composite machine 1. In Step S58, the printing service 130 then establishes a session with the network apparatus 100, and transmits a session ID \mathring{2} 142 indicating the thus-established session to the network apparatus 100.

In Step S59, the network apparatus 100 transmits the session ID \mathring{2} 142 thus received and the ticket 124 acquired in response to the above-mentioned acquisition request made in Step S53, to the printing service 130 of the composite machine 1, and makes a printing request for the stored document.

In Step S60, the printing service 130 transmits the ticket 124 thus received from the network apparatus 100 to the document management service 123, and makes a session start request. In Step S61, the document management service 123 establishes a session with the printing services 130, and transmits a session ID \mathring{3} 144 indicating the thus-established session to the printing service 130.

In Step S62, the printing service 130 transmits the thus-received session ID \mathring{3} 144 together with the ticket 124 to the document management service 123, and makes an acquisition request for ticket information for the purpose of obtaining the arrangement of the document ID corresponding to the ticket 124. In Step S63, the document management service 123 acquires the arrangement of the document ID from the above-mentioned table 126 according to the ticket ID included in the ticket 124 thus received, and transmits the arrangement of the document ID to the printing service 130.

As processing of Steps S64 and S65 executed after the arrangement of the document ID is thus acquired is same as the processing of Steps S28 and S29 shown in FIG. 3, the duplicated description will be omitted.

Thus, in the composite machine 1, with a utilization of the scheme of the ticket 124, printing out of the stored document having passed authentication is achieved without informing the printing service 130 of the password itself. Further, with a utilization of the scheme of the ticket 124, the data itself of the stored document should not be actually transferred, and, thus, resources of the machine can be prevented from being occupied wastefully or a wasteful large load is prevented from being applied to the communications network.

According to this invention described above with reference to the first through third embodiment, as described above, the document management service performs an authentication check on a stored document once. After that, certification information (ticket) is created in response to a certification information acquisition request coming from an external network apparatus. Then, the external network apparatus thus acquires the certification information from the document management service, and the printing service then acquires the certification information from the external network apparatus as a result. Thereby, the authentication function on the stored document can be shared among the plurality of elements of the system.

Furthermore, by transferring the certification information among th external network apparatus, document management service and printing service upon an occurrence of a certification information acquisition request, actual transfer thereamong of the substantial contents of the document themselves can be omitted, for achieving a printing out of the stored document previously stored in the composite machine. Accordingly, it becomes possible to effectively eliminate a wasteful usage of resources in the composite machine, and also, eliminate a wasteful large load from being applied to the communication network.

Furthermore, by transferring session information (session ID) corresponding to the certification information instead of the certification information itself among the external network apparatus, document management service and printing service, as a flow of the certification information itself through the network can be omitted, and thus, it is possible to improve the security protection.

The fourth embodiment of the present invention will now be described.

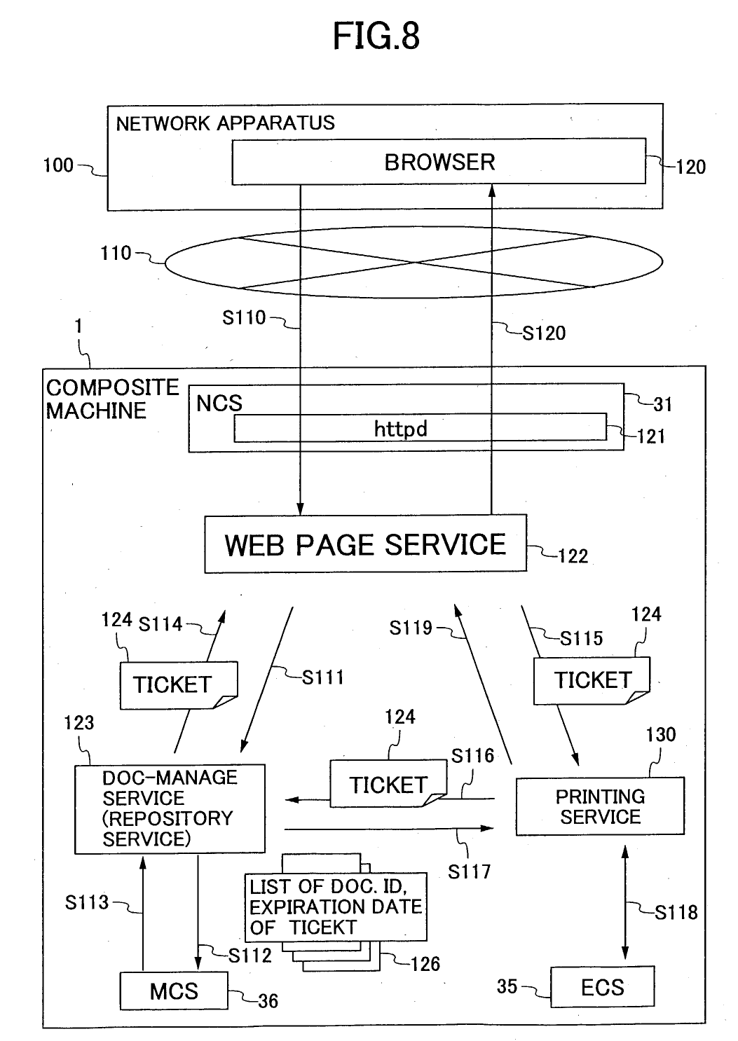

FIG. 8 shows a functional block diagram of the composite machine 1 described above with reference to FIGS. 1 and 2 for illustrating a stored document printing method according to the fourth embodiment of the present invention. Functional parts not needed for the description are omitted in FIG. 8.

As shown in FIG. 8, similar to the configuration shown in FIG. 3 or 6, a network apparatus 100 such as a host computer connected with the composite machine 1 via a network 110 such as the Internet, and document files stored in the composite machine 1 (referred to as ‘stored documents’ as mentioned above), in particular, in the HDD 68 shown in FIG. 2 are made to be printed out through the engine 82 of the composite machine 1.

According to the fourth embodiment, first, a browser 120 of the network apparatus 100 previously receives a list of stored documents stored in the composite machine 1 and corresponding document IDs, from the composite machine 1, using, for example, an HTTP request and an HTTP response, which are well-known. When a user who currently operates the network apparatus 100 inputs a password for printing of a stored document if necessary after choosing the stored document which the user wishes to print out from the above-mentioned list of stored documents, currently displayed on a screen of the browser 120. Then, a predetermined button prepared on the screen of the browser 120 is pressed through a clicking operation with a mouse or so by the user in order that the user makes the composite machine 1 print out the stored document.

In Step S110, the browser 120 of the network apparatus 100 creates an HTTP request containing the document ID of the stored document thus chosen by the user and the password, and transmits them to the composite machine 1 through the network 110, such as the Internet. The HTTP request transmitted from network apparatus 100 is supplied to a Web page service 122 through the httpd 121 of the NCS 31 in the composite machine 1. The Web page service 122 may be included in the Web page application 25 shown in FIG. 1. However, instead, the Web page service may be provided in the control service layer 9.

In Step S111 following Step S110, the Web page service 122 transmits the document ID of the stored document and the password once supplied from the network apparatus 100 to the document management service 123, and makes an acquisition request for a ticket 124 same as that which has been described above. This ticket acquisition request is made using a ticket acquisition function ‘base64 Binary getDocTiccket (arrayOfUnsignedInt DocId and arrayOfString password)’ with the document ID of the stored document and the password regarded as arguments of the function.

The document management service 123 is included in the SF 28 shown in FIG. 1. However, the document management service 123 may be provided in the control service layer 9. In Step S112 following Step S111, the document management service 123 transmits the document ID of the stored document and the password thus received from the Web page service 122 to the MCS 36, and makes an authentication request for the password. This password authentication request is made using a predetermined password authentication request function ‘int mcsCheckPassword (unsignedint DocId and string password)’ with the document ID of the stored document and the password regarded as arguments of the function.

The MCS 36 performs the password attestation on the password thus received from the document management service 123. In Step S113 following Step S112, the MCS 36 transmits a result of the password attestation to the document management service 123. The result of password attestation is thus transmitted to the document management service 123 from the MCS 36 as a return value of, for example, the above-mentioned password authentication request function.

When the password is duly authenticated, the document management service 123 creates a ticket 124 described above with reference to FIGS. 4A and 4B. In Step S114, the document management service 123 transmits the thus-created ticket 124 to the Web page service 122. The ticket 124 is thus transmitted to the Web page service 122 from the document management service 123, for example, as a return value of a ticket acquisition function.

In Step S115 following Step S114, the Web page service 122 transmits the ticket 124 received in Step S14 to the printing service 130, and makes a printing request for the stored document. This stored document printing request is thus made using a stored document printing function ‘void printDocmentsByTick et (base64Binary ticket)’ with the ticket 124 regarded as an argument of the function. The printing service 130 is, for example, included in the printer application 21 shown in FIG. 1. However, the printing service may instead be included in the control service layer 5.

In Step S116 following Step S115, the printing service 130 transmits the ticket 124 received in Step S115 to the document management service 123, and makes an acquisition request thereto for the document ID corresponding to the ticket. This document ID acquisition request is thus made using a document ID acquisition function ‘arrayOfAnyURI getThe document IDsByThicket (base64Binary ticket)’ with the ticket 124 regarded as an argument of the function.

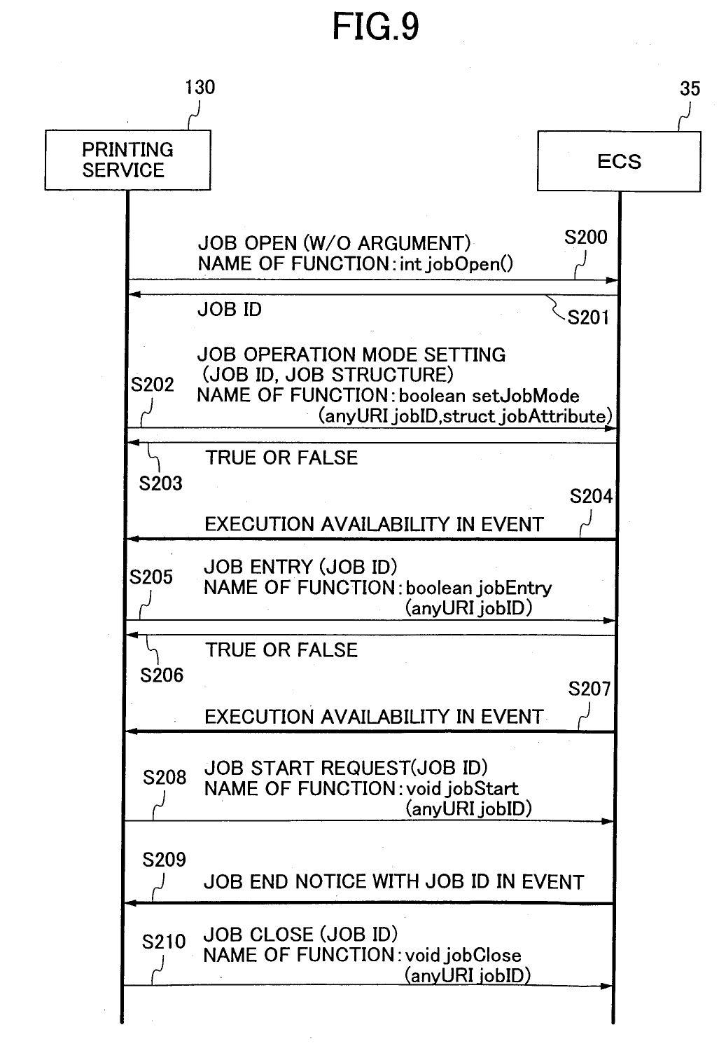

In Step S117 following Step S116, the document management service 123 acquires the document ID from the above-mentioned table 126 shown in FIG. 4B according to the ticket ID contained in the received ticket 124, and transmits the thus-acquired document ID to the printing service 130. The document ID is thus transmitted to the printing service 130 from the document management service 123, for example, as a return value of the above-mentioned document ID acquisition function. With referring to FIG. 9, this stored document printing processing which the printing service 130 and ECS 35 perform will now be described in detail.

FIG. 9 shows an event flow chart of an example of the stored document printing processing which the printing service and ECS perform. In step S200, the printing service 130 requires the ECS 35 to make job opening, using a function. In Step S201 following Step S200, the ECS 35 transmits a job ID to the printing service 130 as a return value of the function.

In Step S202 following Step S201, and the printing service 130 requires the ECS 35 to set a job operation mode using a function. In Step S203 following Step S202, the ECS 35 transmits information indicating a success or a failure in the setting a job operation mode to the printing service 130 as a return value of the function.

In Step S204 following Step S203, the ECS 35 transmits in an event a notice of whether or not execution can be performed to the printing service 130. In Step S205 following Step S204, upon receiving the success information from the ESC 35 in Step S203 and the information indicating that the execution can be performed in Step S204, the printing service 130 requires the ECS 35 to make a job entry using a function. Otherwise, the current processing is ended without proceeding with the subsequent steps.

In Step S206 following Step S205, the ECS 35 transmits information indicating a success or a failure of the job entry to the printing service 130 as a return value of the function. In Step S207 following Step S206, the ECS 35 transmits a notice of whether or not execution can be performed to the printing service 130 in an event. In Step S208 following Step S207, upon receiving the success information from the ESC 35 in Step S206 and the information indicating that the execution can be performed in Step S207, the printing service 130 requires the ECS 35 to make a job start using a function. Otherwise, the current processing is ended without proceeding with the subsequent steps.

In Step S209 following Step S208, upon an end of the relevant job, the ECS 35 transmits a job ID of the job which has thus ended together with a job end notice in an event to the printing service 130. In Step S210 following Step S209, the printing service 130 requires the ESC 35 to make a job closure using a function.

Through the event flow shown in FIG. 9, the printing service 130 can thus perform printing processing for the stored document corresponding to the document ID received in step S117. Then, in Step S119 following Step S118, the printing service 130 transmits information indicating a result of the printing processing to the Web page service 122.

In Step S120, the result of the printing processing which the Web page service 122 thus receives in Step S119 is transmitted to the network apparatus 100 through the httpd 121 of the NCS 31. The network apparatus 100 displays the result of the printing processing received from the composite machine 1 on the screen of the browser 120. Thus, the user in front of the network apparatus 100 can easily print out the desired stored document stored in the composite machine 1 by operating the browser 120 of the network apparatus 100.

Moreover, in the composite machine 1, by using the scheme of the ticket 124, actual transmission of document content data itself of the stored document between the composite machine 1 and network apparatus 100 can be omitted, and thereby, a wasteful usage of resources in the machine can be omitted, as well as a wasteful heavy load which would otherwise occur on the network can be avoided. Furthermore, In the composite machine 1, printing of the stored document having passed an authentication check process can be performed through the printing service 130 with a utilization of the scheme of the ticket 124 thus without inputting a password itself to the printing service 130.

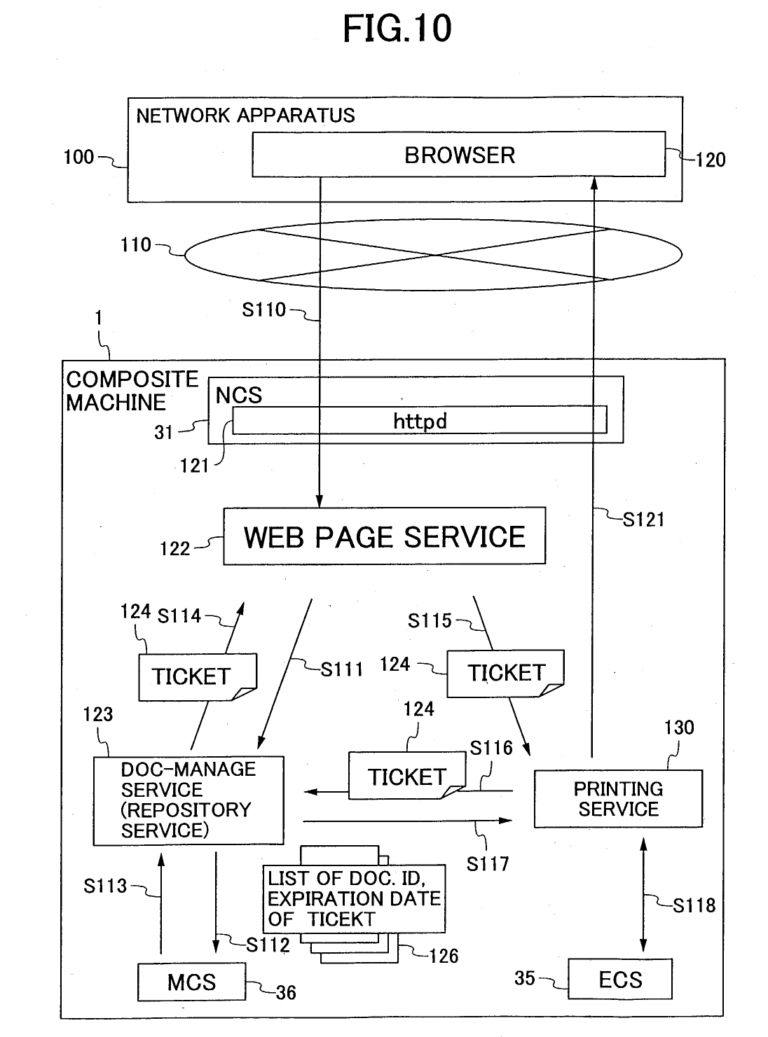

FIG. 10 shows a functional configuration diagram of the composite machine for illustrating a stored document printing method according to the fifth embodiment of the present invention. The functional parts not used for the description are omitted in illustration in the configuration shown in FIG. 10. Since processing of Steps S110 through S118 of FIG. 10 is the same as that of Steps S110 through S118 of FIG. 8, the duplicated description will be omitted.

In this fifth embodiment, Step S121 may be executed immediately after the execution of Step S118, and, the printing service 130 transmits information indicating the result of printing processing directly to the network apparatus 100 not through the Web page service but only through the httpd 121 of the NCS 31. The network apparatus 100 then displays the result of the printing processing received from the composite machine 1 on the screen of the browser 120. Thus, also in this embodiment, the user can easily print out the desired stored document previously stored in the composite machine 1 by operating the browser 120 of the network apparatus 100.

Also in this fifth embodiment, same as in the above-described fourth embodiment, by using the scheme of the ticket 124, actual transmission of document content data itself of the stored document between the composite machine 1 and network apparatus 100 can be omitted, and thereby, a wasteful usage of resources in the machine can be omitted, as well as a wasteful heavy load which would otherwise occur on the network can be avoided. Furthermore, In the composite machine 1, printing of the stored document having passed an authentication check process can be performed through the printing service 130 with a utilization of the scheme of the ticket 124 thus without inputting a password itself to the printing service 130.

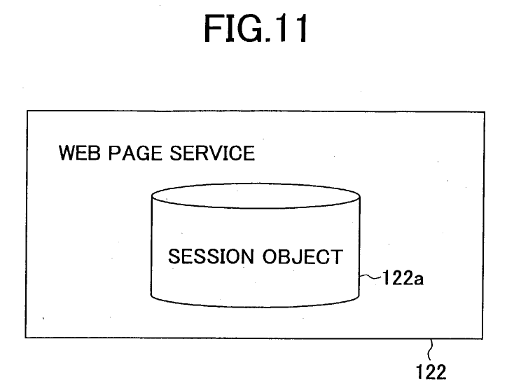

Normally, the Web page service 122 has a function of identifying the browser 120 which has transmitted thereto an HTTP request. As shown in FIG. 11, the Web page service 122 has a session object 122a provided therein, and identifies the browser 120 by using a session managed in this session object 122a.

FIG. 11 illustrates a configuration of the Web service 122 such as that including the session object 122a as mentioned above. The session object 122a provided in the Web page service 122 is provided with a provision enabling an afterwards correspondence with a session ID which indicates a session established with the browser 120. In the session object 122a, the contents of the session thus established with the browser 120 are held.

As the Web page service 122 manages the browser 120 which has transmitted an HTTP request thereto with the session object 122a, the Web page service 122 can easily determine which browser 120 has currently transmitted the HTTP request.

Also in these fourth and fifth embodiments of the present invention, as described above, the document management service performs an authentication check on a stored document once. After that, certification information (ticket) is created in response to a certification information acquisition request from an external network apparatus. Then, the network service (Web page service) acquires the thus-created certification information from the document management service, and the printing service then acquires the certification information from the network service. Thereby, the authentication function on the stored document can be shared among the plurality of elements of the system.

Furthermore, by transferring the certification information among th network service, document management service and printing service upon an occurrence of a certification information acquisition request, actual transfer of the substantial contents of the document themselves among the respective user services in the composite machine can be omitted, for achieving a printing out of the stored document previously stored. Accordingly, it becomes possible to effectively eliminate a wasteful usage of resources in the composite machine.

In case of a stored document output system in which a plurality of composite machines and a network apparatus are connected together via a communication network, various documents may be stored and managed in document management DBs of a plurality of composite machines.

Accordingly, in case passwords are set on stored documents of document management DBs of every composite machine, the stored document output system should have functions for making password authentication for every composite machine one by one.

Further, in case where a stored document of a composite machine is output via another composite machine, the substantial data of the stored document should be transferred between these relevant machines. Thus, network resources and hardware resources of the machines themselves are occupied for this purpose.

Sixth through eighth embodiments of the present invention have been device for the purpose of simplifying a scheme of authentication operations even in a case where a stored document output system includes a plurality of composite machines other than a network apparatus or other than another composite machine, and, also, for the purpose of minimization of actual transfer of substantial data of stored document also even in a case where the stored document output system includes a plurality of composite machines other than a network apparatus or other than another composite machine.

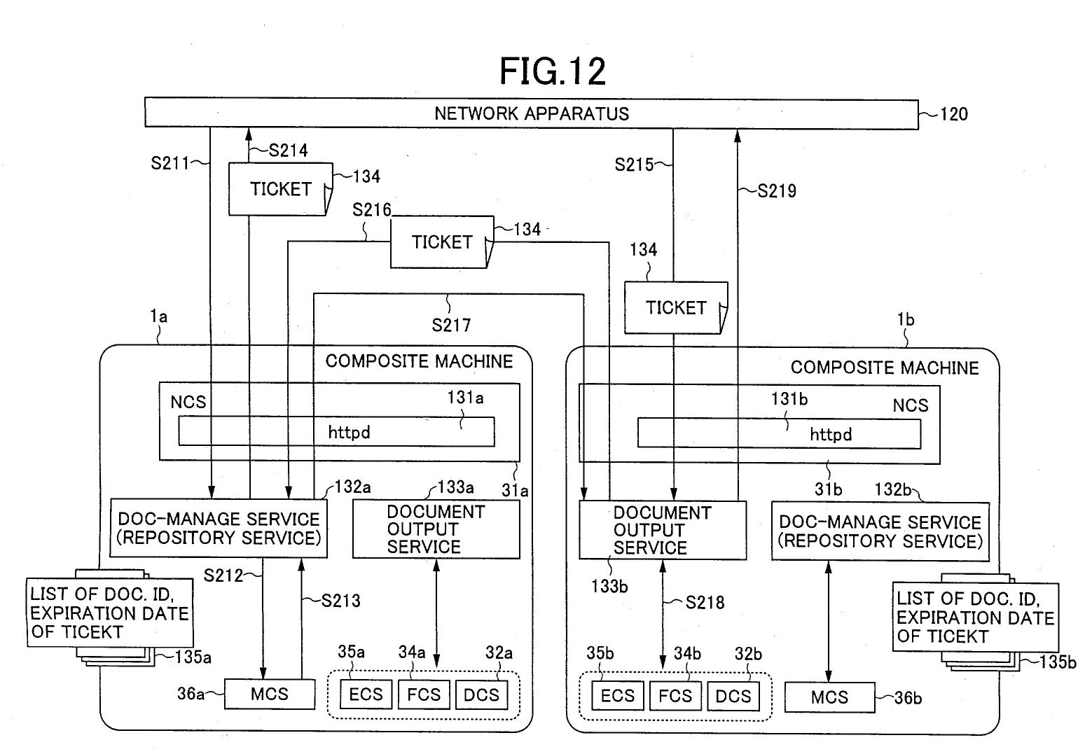

Referring to figures, a stored document output method according to the sixth embodiment of the present invention performed in the composite machine 1 described with reference to FIGS. 1 and 2 will now be described. FIG. 12 shows a functional configuration diagram of the composite machines for illustrating the stored document output method according to the sixth embodiment of the present invention. Functional parts not necessary for illustrating the present embodiment are omitted from FIG. 12.

The stored document output method according to the present embodiment is devised for a user who operates a network apparatus 200 such as a host computer to output (for example, to print out) via a composite machine 1b a stored document which is previously stored in a composite machine la, where both the composite machines 1a and 1b are connected with the network apparatus 200 via a communication network 110 such as the Internet. It is noted that the network apparatus 200 may also be a composite machine similar to the composite machines 1a and 1b.

In FIG. 12, reference numerals same as those shown in FIG. 1 and 2 are used. However, suffixes ‘a’ and ‘b’ are added thereto for the composite machines 1a and 1b, respectively. For example, the NCS 31b is the NCS 31 of the composite machine 1b.

In the stored document output method according to the sixth embodiment, the network apparatus 200, a document management service 132a of the composite machine 1a and a document output service 133b of the composite machine 1b perform data exchange thereamong in use of a well-known XML (extensible markup language). In this data exchange, the stored document output method uses a communication protocol called SOAP (simple object access protocol) as a data access protocol.

First, it is assumed that network apparatus 200 previously receives a list of stored documents and document IDs which are previously stored in the composite machine 1a, from the composite machine 1a itself. Then, when a user who directly operates the network apparatus 200 is requested by the machine to input a password or so for achieving actual outputting of a stored document, after choosing the stored document which the user wishes to print out from the above-mentioned list of stored documents currently displayed on a screen of the apparatus, the user inputs the relevant password or so.

Then, in Step S211 shown in FIG. 12, an acquisition request for a usage ticket (referred simply as a ‘ticket’) 134 is made by the network apparatus 200 for the stored document as the network apparatus 200 transmits the document ID and the password for the stored document chosen by the user, to the document management service 132a of the composite machine 1a through an httpd 131 of the NCS 31a. This ticket acquisition request is made by using the above-mentioned SOAP and XML. The document management service 132a or 132b is acted actually by the WSF 27 and the SF 28 shown in FIG. 1, while the document output service 133a or 133b is acted actually by the WSF 27 and the other SF 28 shown in FIG. 1.

In Step S212 following Step S211, the document management service 132a transmits the document ID and the password for the stored document once received from the network apparatus 200, to the MCS 36a, and makes an authentication request for the password. This password authentication request is made by using a predetermined password authentication request function ‘int mcsCheckPassword (unsignedint DocId, string password)’ with the document ID and the password as arguments thereof. The MCS 36a performs the password authentication using the document ID and the password thus received from the document management service 132a.

In Step S213 following Step S212, the MCS 36a transmits a result of this password authentication to the document management service 132a. The result of password authentication is thus transmitted to the document management service 132a from the MCS 36a as a return value of, for example, the above-mentioned password authentication request function.

After the password authentication on the document ID is thus completed normally without failure with the password, the-document management service 132a create a ticket 134 which may be same as that described above-mentioned with reference to FIGS. 4A and 4B. According to the sixth embodiment, the ticket 134 is transferred among the network apparatus 200, the document management service 132a of the composite machine 1a and the document output service 133b of the composite machine 1b in this example. With reference to FIG. 4B, a table 135a shown is used for checking the ticket 134 in this embodiment. The data of the table 135a is held by the document management service 132a. The table 135a includes information indicating the contents of the ticket, and ticket management information. The ticket content information has the ticket ID, expiration date of the ticket, a relevant number of relevant files and an arrangement of structure containing a file ID which includes the relevant document ID and password as a pair, as described above with reference to FIG. 4B. The ticket management information has the current ticket number and the number of issued tickets. A provision is made enabling afterwards mutual correspondence between the table 135a and the ticket 134 itself by the ticket ID.

In Step S214, the document management service 132a transmits the thus-created ticket 134 to the network apparatus 200 through the httpd 131a of the NCS 31a. The transmission of the ticket 134 from the document management service 132a to the network apparatus 200 is performed using the SOAP and XML.

In Step S215, the network apparatus 200 transmits the ticket 134 once received in Step S214, to the document output service 133b of the composite machine 1b through the httpd 131b of the NCS31b, and makes an outputting request for the stored document. The outputting request for the stored document is performed using the SOAP and XML. The document output service 133b is acted by the WSF27 and SF 28 shown in FIG. 1, as mentioned above.

In Step S216, the document output service 133b transmits the ticket 134 received in Step S215 to the document management service 132a of the composite machine 1a through the NCS 31b and the httpd 131a of the NCS 31a, and makes an acquisition request thereto for the stored document corresponding to the ticket 134.

It is noted that the document output service 133b of the composite machine 1b performs data exchange with the document management service 132a of the composite machine 1a in a form of XML using a communication protocol called SOAP as a data access protocol.

In Step S217, the document management service 132a acquires the document ID from the above-mentioned table 135a according to the ticket ID contained in the received ticket 134, and reads the stored document corresponding to the document ID from the document management DB in the composite machine 1a itself. The document management service 132a transmits the stored document thus read out to the document output service 133b of the composite machine 1b through the httpd 131a of the NCS 31a and the NCS 31b.

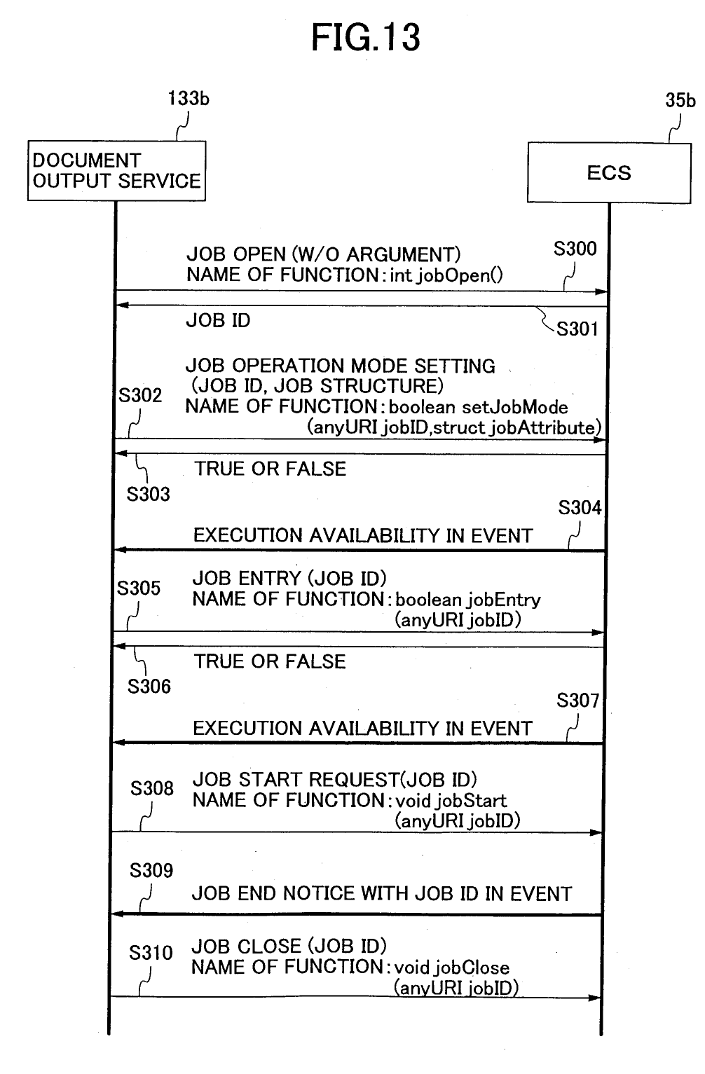

In Step S218, the document output service 133b transmits the stored document thus received in Step S217 to the DCS 32b, FCS 34b, and ECS 35b, and performs output processing on the stored document therethrough. With reference to FIG. 13, as an example of the stored document outputting or printing processing which the document output service 133b and the ECS 35b perform will now be described.

FIG. 13 shows an event flow chart of an example of the stored document printing processing which the printing service and ECS perform. In step S300, the document output service 133b requires job opening of the ECS 35b using a function. In Step S301 following Step S300, the ECS 35b transmits a job ID to the document output service 133b as a return value of the function.

In Step S302 following Step S301, and the document output service 133b requires the ECS 35b to set a job operation mode using a function. In Step S303 following Step S302, the ECS 35b transmits information indicating a success or a failure in the setting a job operation mode to the document output service 133b as a return value of the function.

In Step S304 following Step S303, the ECS 35b transmits in an event a notice of whether or not execution can be performed to the document output service 133b. In Step S305 following Step S304, upon receiving the success information from the ESC 35b in Step S303 and the information indicating that the execution can be performed in Step S304, the document output service 133b requires the ECS 35b to make a job entry using a function. Otherwise, the current processing is ended without proceeding with the subsequent steps.

In Step S306 following Step S305, the ECS 35b transmits information indicating a success or a failure of the job entry to the document output service 133b as a return value of the function. In Step S307 following Step S306, the ECS 35b transmits a notice of whether or not execution can be performed to the document output service 133b in an event. In Step S308 following Step S307, upon receiving the success information from the ESC 35 in Step S106 and the information indicating that the execution can be performed in Step S307, the document output service 133b requires the ECS 35b to make a job start using a function. Otherwise, the current processing is ended without proceeding with the subsequent steps.

In Step S309 following Step S308, upon an end of the relevant job, the ECS 35b transmits a job ID of the job which has thus ended together with a job end notice in an event to the document output service 133b. In Step S310 following Step S309, the document output service 133b requires the ESC 35b to make a job closure using a function. Thus, by the event flow as shown in FIG. 13, the document output service 133b can perform document output processing for the stored document received in Step S217.

In Step S219 following Step S218, the document output service 133b transmits a result of the above-mentioned document output processing to the network apparatus 200 through the httpd 131b of the NCS 31b. The network apparatus 200 displays, on its screen, the result of the output processing thus received from the composite machine 1b. Thus, the user can output easily the desired stored document stored in the composite machine 1a via the composite machine 1b by directly operating the network apparatus 200 using the document management service 132a of the composite machine 1a.

Moreover, in the stored document output system described above with reference to FIG. 12, wasteful transmission of the data of the stored document itself between the composite machines 1a and 1b can be omitted by using the scheme of the ticket 134, and thus, network resources and the hardware resources 4 of the composite machines 1a and 1b can be free from being used for wastefully transmitting the document data itself. Furthermore, the outputting of the stored document having passed authentication can be achieved without informing the document output service 133b of the password itself by using the scheme of the ticket 134 in the stored document output system of FIG. 12.

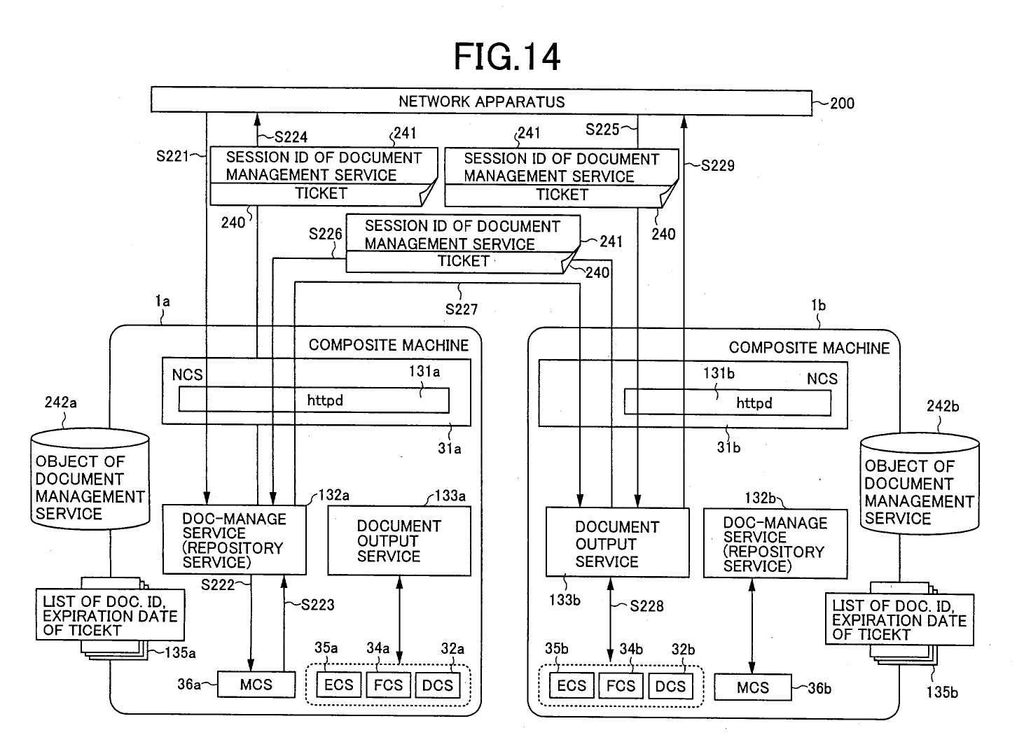

FIG. 14 shows a functional configuration diagram of the composite machines 1a and 1b such as those each of which is described above with reference to FIGS. 1 and 2 for illustrating a stored document output method according to the seventh embodiment of the present invention. Functional parts not necessary for illustrating the seventh embodiment are omitted in FIG. 14.

According to the seventh embodiment, first, the network apparatus 200 makes a session start request to the composite machine 1a, establishes a session with the document management service 132a, and, then, Step S221 is performed. Hereinafter, a session thus established between the network apparatus 200 and document management service 132a is referred to as ‘a session of document management service’. Further, a session ID used for identifying the session of document management service is referred to as a ‘session ID of document management service’, hereinafter.

In Step S221, the network apparatus 200 makes ticket acquisition request for a ticket 240 to the document management service 132a of the composite machine 1a by transmitting the document ID selected by the user and password input by the user thereto via an httpd 131a of the NCS 31a. Similarly to the above-described sixth embodiment, the document management service 132b/132a and document output service 133a/133b shown in FIG. 14 are acted by the WSF 27 and SFs 28.

In Step S222 following Step S221, the document management service 132a transmits the document ID and the password of the stored document thus received from the network apparatus 200 to the MCS 36a, and makes an authentication request on the password. The MCS 36a then performs the password authentication using the document ID and the password which once received from the document management service 132a.

In Step S223 following Step S222, the MCS 36a transmits a result of this password authentication to the document management service 132a. After the password authentication on the document ID is thus completed with the password duly without failure, the document management service 132a creates the ticket 240 such as the thicket 134 described above in the description of the sixth embodiment.

In Step S224, the document management service 132a transmits the created ticket 240 and the session ID 241 of document management service to the network apparatus 200 through the httpd 131a of the NCS31a.

In Step S225, the network apparatus 200 transmits the ticket 240 and the session ID 241 of document management service once received in Step S224, to the document output service 133b of the composite machine 1b through the httpd 131b of the NCS 31b, and makes an outputting request thereto for the stored document.

In Step S226, the document output service 133b transmits the ticket 240 and the session ID 241 of document management service once received in Step S225, to the document management service 132a of the composite machine 1a through the httpd 131b of the NCS 31b and the NCS31a, and performs an acquisition request for the stored document corresponding to the ticket 240.

In Step S227, the document management service 132a acquires the document ID from the table 135a, such as that described above in the description of the sixth embodiment managed by the document management service 132a for managing ticket information, according to the ticket ID contained in the received ticket 240, and reads out the stored document corresponding to the document ID, from the document management DB in the composite machine 1a. The document management service 132a transmits the thus-read-out stored document to the document output service 133b of the composite machine 1b through the httpd 131a of the NCS 31a and the NCS 31b.

As processing of Steps S228 through S229 executed after the document output service 133b of the composite machine 1b acquires the stored document from the document management service 132a of the composite machine 1a is same as the processing of Steps S218 through S219 described above with reference to FIG. 12, duplicated description will be omitted.

Thus, a user can output easily the stored document stored in the composite machine 1a via the composite machine 1b by directly operating the network apparatus 200 using the document management service 132a of the composite machine 1a.

Further, in the stored document output system described above with reference to FIG. 14, by using the scheme of the ticket 240 and the session ID 241 of the document management service, transmission of the actual data of the stored document itself between the composite machines 1a and 1b can be reduced to the minimum occasion, and thus, network resources and the hardware resources 4 of the composite machines 1a and 1b can be prevented from being occupied for a wasteful work of document data transmission. Moreover, the outputting or printing out of the stored document having passed authentication can be achieved without informing the document output service 133 of the password itself by using the ticket 240 and the session ID 241 of document management service in the stored document output system of FIG. 14. Furthermore, improving in the security protection can be achieved by using the session ID 241 of the document management service in the stored document output system of FIG. 14.

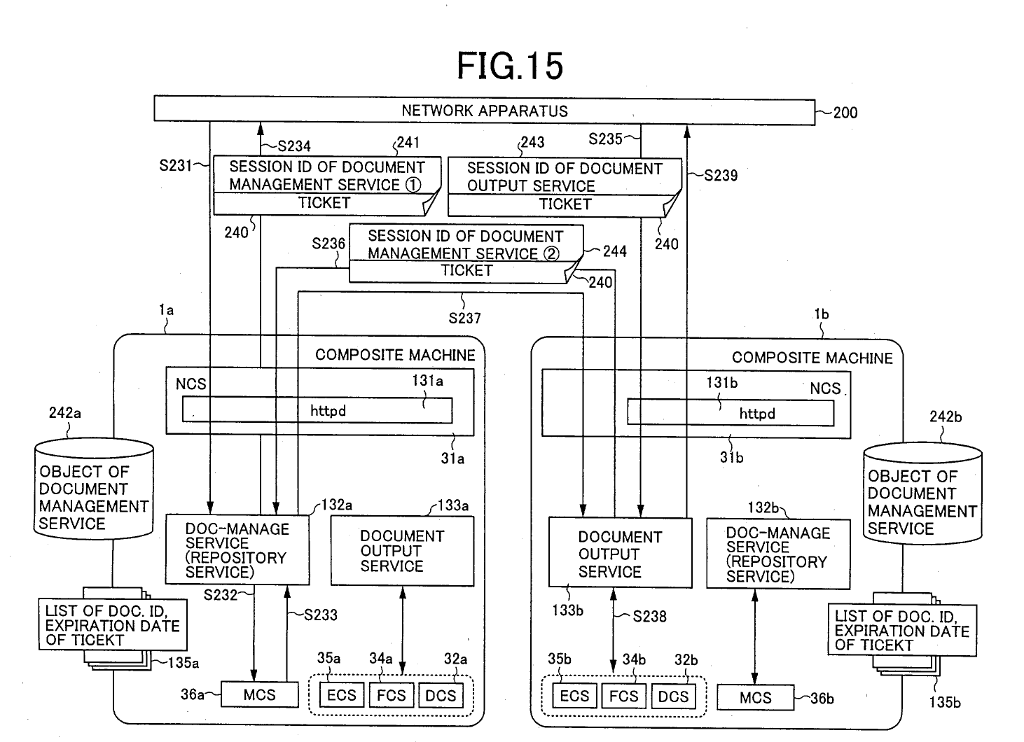

FIG. 15 shows a functional configuration diagram of composite machines, each of which has the same configuration as that described above with reference to FIGS. 1 and 2, for illustrating a stored document outputting method according an eighth embodiment of the present invention. Functional parts not necessary for illustrating the eighth embodiment are omitted from FIG. 15.

In the system configuration shown in FIG. 15, similar to those shown in FIGS. 12 and 14, a network apparatus 200 such as a host computer is connected with two composite machines, each of which has the same configuration as that described above with reference to FIGS. 1 and 2, via a communication network such as the Internet. In this system configuration, in order to output or print out a stored document in the composite machine 1a via the composite machine 1b, upon the relevant request input by a user, the network apparatus 200 first makes a session start request to a document management service 132a of the composite machine 1a, establishes a session with the document management service 132a, and executes Step S231.

It is noted that a session established between the network apparatus 200 and the document management service 132a is referred to as a session \mathring{1} of document management service, and a session ID for identifying the session \mathring{1} of document management service is referred to as a session ID \mathring{1} of document management service, hereinafter. Further, as processing of Steps S231 through S234 of FIG. 15 is the same as the processing of Steps S221 through S224 of FIG. 14, duplicated description will be omitted.

When a ticket 240 and a session ID \mathring{1} 241 of document management service are thus received at Step S234, the network apparatus 200 makes a session start request to the document output service 133b of the composite machine 1b, establishes a session with the document output service 133b, and executes Step S235.

It is noted that such a session established between the network apparatus 200 and the document output service 133b is referred to as ‘a session of document output service’, and a session ID for identifying the session of document output service is referred to as a session ID of document output service, hereinafter.

In Step S235, the network apparatus 200 transmits the ticket 240 received in Step S234 and the above-mentioned session ID 243 of document output service, to the document output service 133b of the composite machine 1b through an httpd 131b of the NCS 31b, and makes an outputting request thereto for the relevant stared document. When the ticket 240 and the session ID 243 of document output service are received in Step S235, the document output service 133b makes a session start request to the document management service 132a of the composite machine 1a, establishes a session with the document management service 132a, and executes Step S236. It is noted that such a session thus established between the document output service 133b and the document management service 132a is referred to as a ‘session \mathring{2} of document management service, and a session ID for identifying the session \mathring{2} of document management service is referred to as a session ID \mathring{2} of document management service, hereinafter.

In Step S236, the document output service 133b transmits the ticket 240 received in Step S235 and the above-mentioned session ID \mathring{2} 244 of document management service, to the document management service 132a of the composite machine 1a through the NCS 31b and the httpd 131a of the NCS31a, and makes an acquisition request for the stored document corresponding to the ticket 240. In Step S237, the document management service 132a acquires a document ID from a table 135a, such as that described above in the sixth and seventh embodiments managed by the document management service 132a for managing ticket information, according to the ticket ID contained in the thus-received ticket 240, and reads out the stored document corresponding to this document ID, from the document management DB in the composite machine 1a.

The document management service 132a transmits the thus-read-out stored document to the document output service 133b of the composite machine 1b through the httpd 131a of the NCS 31a and the NCS 31b. As processing of Steps S238 through S239 executed after the document output service 133b of the composite machine 1b thus acquires the stored document from the document management service 132a of the composite machine 1a is same as the processing of Steps S218 through S219 of FIG. 12, duplicated description is omitted.

Thus, the user can output or print out easily the stored document stored in the composite machine 1a, via the composite machine 1b, by directly operating the network apparatus 200 using the document management service 132a of the composite machine 1a, also in the eighth embodiment.

Further, the stored document output system of FIG. 15 can achieve efficient usage of network resources and the hardware resources 4 of the composite machines 1a and 1b by controlling necessary occurrences of actual substantial document data transfer processing to the minimum possible by using the scheme of the ticket 240, session ID \mathring{1} 241 of document management service, session ID 243 of document output service and session ID \mathring{2} 244 of document management service.

Moreover, outputting or printing out of the desired stored document having passed necessary authentication becomes possible without a need of informing the document output service 133b of the composite machine 1b the password itself in the stored document output system of FIG. 15. Furthermore, the security protection level can be further improved by using these session ID \mathring{1} 241 of document management service, session ID 243 of document output service and session ID \mathring{2} 244 of document management service.

In each of the above-mentioned sixth through eighth embodiment of the present invention, the network apparatus 200 connected to the composite machines 1a and 1b through the communication network makes the stored document stored in the composite machine 1a to be output or printed out via the composite machine 1b. However, it is also possible that another composite machine 1c, which may have the same configuration as that described above with reference to FIGS. 1 and 2, which is also connected to the composite machines 1a and 1b via the communication network, makes the stored document stored in the composite machine 1a to be output or printed out via the composite machine 1b, instead of the network apparatus 200.

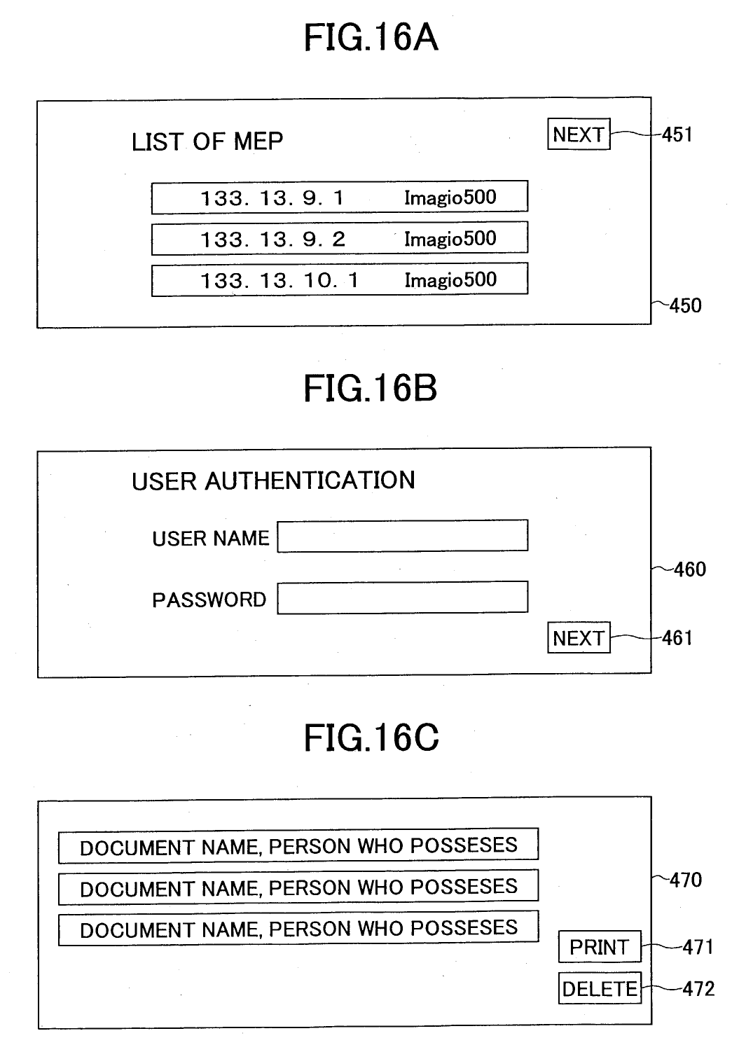

In such a system configuration described immediately above, for the purpose of achieving output or printing out of the stored document of the composite machine 1a via the composite machine 1b, the composite machine 1c first obtains a list of other composite machines connected through the network. For example, IP addresses, names, etc. of respective composite machines are contained in the list of other composite machines. When instructions are given by a user, the composite machine 1c displays a page 450 of the list of other composite machines connected through the network, on the operation panel 80 of its own, as shown in FIG. 16A.

FIGS. 16A through 16C illustrate an example of pages displayed on the operation panel 80 for a user to select first a composite machine which has a desired stored document, and second, to select the stored document, as will now be described. In this example, it is assumed that the user wishes to makes the composite machine 1b print a stored document stored in the composite machine 1a. In this case, the user chooses from the above-mentioned list of the page 450 the composite machine 1a which has the desired stored document stored therein, and presses a ‘NEXT’ button 451 on the page 450. In case an input of a user's name and a password is required for printing of the stored document, the composite machine 1c displays a page 460 for inputting a user's name and a password on the operation panel 80, as shown in FIG. 16B. After the user inputs a user's name and a password into the page 460 by a keyboard operation, the user presses a ‘NEXT’ button 461 on the page 460.

When the ‘NEXT’ button 461 is pressed, the composite machine 1c performs a user authentication operation on the thus-input user's name and password, and displays a list of stored documents of the composite machine 1a selected previously as mentioned above, as shown in FIG. 16C. In this case, this list may only include documents which the particular user thus authenticated can handle by himself or herself in terms of security level. Then, after the user chooses a stored document from the list which he or she wishes to print out, which list of stored documents is currently displayed on the page 470 shown in FIG. 16C, and he or she presses a ‘PRINT’ button 471. Then, the composite machine 1c performs any of Steps S211, S221, or S231 mentioned above with reference to FIG. 12, 14 or 15, and, then, the relevant set of subsequent steps also shown in the relevant one of these figures. A button 472 ‘DELETE’ is provided for a user to delete the stored document chosen from the list of stored documents, which is chosen as a stored document to be printed out.

Thus, the user can print out easily the stored document stored in the composite machine 1a via the composite machine 1b by directly operating the composite machine 1c using the composite machines 1a and 1b connected to the composite machine 1c through the network. In addition, it is also possible to print out a stored document stored in the composite machine 1a via the composite machine 1c, as another example.

In the sixth through eighth embodiments described above, the ticket 134/240 is applied as an example of information for achieving a stored document usage authentication certification. However, any another information can also be used for the same purpose which can certify a usage right on a stored document. Furthermore, the session ID 241 is used in the seventh or eighth embodiment as an example of information for achieving a document management service usage authentication certification. However, any other information can also be used for the same purpose which can certify a usage right on the document management service 132a, for example.

Thus, according to the present invention in particular concerning the above-mentioned sixth through eighth embodiments, the document management service creates certification information on a stored document stored in a document storage device. Then, identification information on the stored document corresponding to the certification information is then created. Then, the document output service of another image forming apparatus performs outputting of the stored document by using the above-mentioned identification information of the stored document. Accordingly, the authentication function on the stored document is efficiently shared by the many parts/devices in the system.

Furthermore, by utilization of the certification information, transfer of data of a stored document itself between a plurality of image forming apparatuses can be reduced to the minimum occasion. Accordingly, efficient usage of network resources and hardware resources of image forming apparatuses can be achieved.

Further, the present invention is not limited to the above-described embodiments, and variations and modifications may be made without departing from the basic concept of the present invention.

The present application is based on Japanese priority applications Nos. 2002-164407, 2002-164408 and 2002-215542, filed on Jun. 5, 2002, Jun. 5, 2002 and Jul. 24, 2002, respectively, the entire contents of which are hereby incorporated by reference.

What is claimed is

1. An image forming apparatus comprising a hardware resource used for image formation, a program for performing processing concerning image formation, and a document storage for storing a stored document, comprising:
a document management service receiving a certification information acquisition request for the stored document stored in said document storage from another apparatus via a network, and providing certification information in response to the certification information acquisition request; and
a printing service receiving a stored document printing request from the other apparatus with a utilization of the certification information, and printing out the stored document in response to the certification information.

2. An image forming apparatus comprising a hardware resource used for image formation, a program for performing processing concerning image formation, and a document storage for storing a stored document, comprising:
a document management service receiving a certification information acquisition request for the stored document stored in said document storage from another apparatus via a network, and providing session information configured to be directly or indirectly related to certification information in response to the certification information acquisition request; and
a printing service receiving from the other apparatus a stored document printing request with a utilization of the session information, and printing out the stored document in response to the certification information directly or indirectly related to by said session information.

3. An image forming apparatus comprising a hardware resource used for image formation, a program for performing processing concerning image formation, and a document storage for storing a stored document, comprising:
a document management service receiving a certification information acquisition request and first session information for the stored document stored in said document storage from another apparatus via a network, and providing certification information in response to the certification information acquisition request; and
a printing service receiving from the other apparatus a stored document printing request with a utilization of the certification information and second session information, and printing out the stored document according to the certification information.

4. The image forming apparatus as claimed in claim 3, wherein:
said document management service creates the certification information in response to the certification information acquisition request and transmits it to the other apparatus, while receiving the certification information and third session information from said printing service and transmitting to said printing service identification information for the stored document in response to the certification information.

5. The image forming apparatus as claimed in claim 3, wherein:
said printing service receives the stored document printing request from the other apparatus with a utilization of the certification information and second session information as well as receiving identification information for the stored document in response to said certification information from said document management apparatus, and, also, printing out the stored document according to said identification information after acquiring it from said document management service.

6. The image forming apparatus as claimed in claim 3, wherein:
said printing service prints out the stored document according to the certification information after acquiring it from said document management service, and, also, provides to said other apparatus printing processing information concerning the relevant printing processing.

7. The image forming apparatus as claimed in claim 3, wherein:
said document management service crates contents of the certification information and identification information in response to the certification information acquisition request, and transmits the identification information to said other apparatus, as well as holding the contents of the certification information.

8. The image forming apparatus as claimed in claim 7, wherein:
said document management service uses the identification information for the certification information sent from said printing service for identifying the contents of the certification information, as well as transmitting the identification information according to the contents of the certification information.

9. The image forming apparatus as claimed in claim 3, wherein:
said document management service uses a predetermined function to acquire the certification information in response to the certification acquisition request.

10. The image forming apparatus as claimed in claim 4, wherein:
said printing service uses a predetermined function to acquire the identification information in response to the certification information.

11. The image forming apparatus as claimed in claim 3, wherein:
said printing service uses a predetermined function to print out the stored document according to the certification information.

12. The image forming apparatus as claimed in claim 3, wherein:
said first session information indicates a session between said document management services and said other apparatus;
said second session indicates a session between said printing service and said other apparatus; and
said third session indicates a session between said document management service and said printing service.

13. The image forming apparatus as claimed in claim 1, wherein:
said certification information acquisition request at least comprises identification information for identifying the stored document, and certification information for certifying a usage right on the stored document.

14. The image forming apparatus as claimed in claim 2, wherein:
said certification information acquisition request at least comprises identification information for identifying the stored document, and certification information for certifying a usage right on the stored document.

15. The image forming apparatus as claimed in claim 3, wherein:
said certification information acquisition request at least comprises identification information for identifying the stored document, and certification information for certifying a usage right on the stored document.

16. The image forming apparatus as claimed in claim 1, wherein:
said document management service, said printing service and said other apparatus make mutual communications in use of a simple object access protocol.

17. The image forming apparatus as claimed in claim 2, wherein:
said document management service, said printing service and said other apparatus make mutual communications in use of a simple object access protocol.

18. The image forming apparatus as claimed in claim 3, wherein:
said document management service, said printing service and said other apparatus make mutual communications in use of a simple object access protocol.

19. A stored document printing method for an image forming apparatus comprising a hardware resource used for image formation, a program for performing processing concerning image formation, and a document storage for storing a stored document, said method comprising the steps of:
a) receiving a certification information acquisition request for the stored document stored in said document storage from another apparatus via a network, and providing certification information in response to the certification information acquisition request; and
b) receiving a stored document printing request from the other apparatus with a utilization of the certification information, and printing out the stored document according to the certification information.

20. A stored document printing method for an image forming apparatus comprising a hardware resource used for image formation, a program for performing processing concerning image formation, and a document storage for storing a stored document, said method comprising the steps of:
a) receiving a certification information acquisition request for a stored document stored in said document storage from another apparatus via a network, and providing session information configured to be directly or indirectly related to certification information in response to the certification information acquisition request; and
b) receiving from the other apparatus a stored document printing request with a utilization of the session information, and printing out the stored document according to the certification information directly or indirectly related to by said session information.

21. A stored document printing method for an image forming apparatus comprising a hardware resource used for image formation, a program for performing processing concerning image formation, and a document storage for storing a stored document, said method comprising the steps of:
a) receiving a certification information acquisition request and first session information for the stored document stored in said document storage from another apparatus via a network, and providing certification information in response to the certification information acquisition request; and
b) receiving from the other apparatus a stored document printing request with a utilization of the certification information and second session information, and printing out the stored document according to the certification information.

22. A stored document printing system using at least one other apparatus, and an image forming apparatus which is connected with said other apparatus via a network, and printing out a stored document stored in a document storage of said image forming apparatus, said image forming apparatus comprising:
a document management service receiving a certification information acquisition request for the stored document stored in said document storage from said others apparatus via the network, and providing certification information in response to the certification information acquisition request; and
a printing service receiving from the other apparatus a stored document printing request with a utilization of the certification information, and printing out the stored document according to the certification information.

23. A stored document printing system using at least one other apparatus, and an image forming apparatus which is connected with said other apparatus via a network, and printing out a stored document stored in a document storage of said image forming apparatus, said image forming apparatus comprising:
a document management service receiving a certification information acquisition request for the stored document stored in said document storage from said other apparatus via the network, and providing session information configured to be directly or indirectly related to certification information in response to the certification information acquisition request; and
a printing service receiving from the other apparatus a stored document printing request with a utilization of the session information, and printing out the stored document according to the certification information directly or indirectly related to by said session information.

24. A stored document printing system using at least one other apparatus, and an image forming apparatus which is connected with said other apparatus via a network, and printing out a stored document stored in a document storage of said image forming apparatus, said image forming apparatus comprising:
a document management service receiving a certification information acquisition request and first session information for the stored document stored in said document storage from said other apparatus via the network, and providing certification information in response to the certification information acquisition request; and
a printing service receiving from the other apparatus a stored document printing request with a utilization of the certification information and second session information, and printing out the stored document in response to the certification information.

25. An image forming apparatus comprising a hardware resource used for image formation, a program for performing processing concerning image formation, and a document storage for storing a stored document, comprising:
a network service receiving a stored document printing request for the stored document stored in said document storage from another apparatus via a network;
a document management service creating certification information in response to said stored document printing service, and transmitting it to said network service; and
a printing service receiving said certification information from said network service, acquiring the stored document according to said certification information, and printing the same.

26. An image forming apparatus comprising a hardware resource used for image formation, a program for performing processing concerning image formation, and a document storage for storing a stored document, comprising:
a network service receiving a stored document printing request for the stored document stored in said document storage from another apparatus via a network;
a session object managing information of a session established with said other apparatus, and the stored document printing request received from said other apparatus, provided with a direct or indirect relation therebetween;
a document management service creating certification information in response to said stored document printing request, and transmitting it to said network service; and
a printing service receiving said certification information from said network service, acquiring the stored document according to said certification information, and printing the same.

27. The image forming apparatus as claimed in claim 26, wherein:
said network service receives from said other apparatus the stored document printing request for the stored document stored in said document storage, and acquires the certification information in response to said stored document printing request, as well as transmitting a stored document printing request to said printing service with a utilization of said certification information.

28. The image forming apparatus as claimed in claim 26 wherein:
said document management service creates the certification information in response to said stored document printing request and transmits the same to said network service, as well as transmitting to said printing service identification information for the stored document in response to said certification information.

29. The image forming apparatus as claimed in claim 26, wherein:
said printing service receives the store information printing request with a utilization of the certification information from said network service, and acquires identification information for the stored document according to said certification information from said document management service, as well as acquiring the stored document according to said identification information from said document storage, and printing the same.

30. The image forming apparatus as claimed in claim 26, wherein:
said printing service provides printing processing information concerning relevant printing processing; and
said network service identifies with a utilization of said session object said other apparatus which has transmitted said stored document printing request, and transmits to said other apparatus the printing processing information sent from said printing service.

31. The image forming apparatus as claimed in claim 25, wherein:
said printing service provides printing processing information concerning relevant printing processing to said other apparatus.

32. The image forming apparatus as claimed in claim 25, wherein:
said stored document printing request at least comprises identification information for identifying the stored document, and certification information for certifying a usage right on the stored document.

33. The image forming apparatus as claimed in claim 25, wherein:
said document management service creates contents of the certification information and identification information in response to said stored document printing request, and transmits said identification information of said certification information to said network service as certification information, as well as holding the contents of said certification information.

34. The image forming apparatus as claimed in claim 33, wherein:
said network service transmits the stored document printing request including the identification information of the certification information, to said printing service: and
said document management service determines the contents of the certification information with a utilization of said identification information of the certification information sent from said printing service, as well as transmitting identification information of the stored document according to the contents of said certification information, to said printing service.

35. The image forming apparatus as claimed in claim 26, wherein:
said network service uses a predetermined function to acquires the certification information in response to said stored document printing request.

36. The image forming apparatus as claimed in claim 30, wherein:
said printing service uses a predetermined function to acquires the stored document according to said certification information.

37. The image forming apparatus as claimed in claim 31, wherein:
said printing service uses a predetermined function to acquires the stored document according to said certification information.

38. The image forming apparatus as claimed in claim 30, wherein:
said printing service uses a predetermined function to causes a memory control service to acquire the stored document from said document storage according to said certification information, and provide the same.

39. The image forming apparatus as claimed in claim 31, wherein:
said printing service uses a predetermined function to causes a memory control service to acquire the stored document from said document storage according to said certification information, and provide the same.

40. The image forming apparatus as claimed in claim 30, wherein:
said printing service uses a predetermined function to print out the stored document according to said certification information.

41. The image forming apparatus as claimed in claim 31, wherein:
said printing service uses a predetermined function to print out the stored document according to said certification information.

42. The image forming apparatus as claimed in claim 30, wherein:
said printing service uses a predetermined function to cause an engine control service to print out the stored document according to said certification information.

43. The image forming apparatus as claimed in claim 31, wherein:
said printing service uses a predetermined function to cause an engine control service to print out the stored document according to said certification information.

44. The image forming apparatus as claimed in claim 26, wherein:
said other apparatus comprises one of a network apparatus and an image forming apparatus.

45. A stored document printing method for an image forming apparatus comprising a hardware resource used for image formation, a program for performing processing concerning image formation, and a document storage for storing a stored document, said method comprising the steps of:
a) receiving a stored document printing request for the stored document stored in said document storage from another apparatus via a network;
b) creating certification information in response to said stored document printing service; and
c) receiving said certification information from a network service, acquiring the stored document according to said certification information, and printing the same.

46. A stored document printing method for an image forming apparatus comprising a hardware resource used for image formation, a program for performing processing concerning image formation, and a document storage for storing a stored document, said method comprising the steps of:
a) receiving a stored document printing request for the stored document stored in said document storage from another apparatus via a network;
b) managing information of a session established with said other apparatus, and the stored document printing request received from said other apparatus, with a provision of a direct or indirect relation therebetween;
c) creating certification information in response to said stored document printing request; and
d) receiving said certification information from a network service, acquiring the stored document in response to said certification information, and printing the same.

47. A stored document printing system using at least one other apparatus, and an image forming apparatus connected with said other apparatus via a network, for printing out a stored document stored in a document storage of said image forming apparatus, said image forming apparatus comprising:
a network service receiving a stored document printing request for the stored document stored in said document storage from said other apparatus via the network;
a document management service creating certification information in response to said stored document printing request, and transmitting it to said network service; and
a printing service receiving said certification information from said network service, acquiring the stored document according to said certification information, and printing the same.

48. A stored document printing system using at least one other apparatus, and an image forming apparatus connected with said other apparatus via a network, for printing out a stored document stored in a document storage of said image forming apparatus, said image forming apparatus comprising:
a network service receiving a stored document printing request for the stored document stored in said document storage from said other apparatus via the network;
a session object managing information of a session established with said other apparatus, and the stored document printing request received from said other apparatus, with a provision of a direct or indirect relationship therebetween;
a document management service creating certification information in response to said stored document printing request, and transmitting it to said network service; and
a printing service receiving said certification information from said network service, acquiring the stored document according to said certification information, and printing the same.

49. An image forming apparatus comprising a hardware resource used for image formation, a program for performing processing concerning image formation, and a document storage for storing a stored document, comprising:
a document management service receiving a certification information acquisition request for the stored document stored in said document storage from one apparatus via a network, and providing certification information in response to the certification information acquisition request to said one apparatus; as well as
receiving from another apparatus connected via the network a stored document acquisition request with a utilization of said certification information, and transmitting the stored document according to said certification information to said other apparatus.

50. An image forming apparatus comprising a hardware resource used for image formation, a program for performing processing concerning image formation, and a document storage for storing a stored document, comprising:
a document output service receiving certification information for the stored document stored in another apparatus, from one apparatus, both connected via a network, and transmitting a stored document acquisition request with a utilization of said certification information, to said other apparatus, while:
upon receiving the stored document according to said certification information from said other apparatus, said document output service outputs the stored document.

51. An image forming apparatus comprising a hardware resource used for image formation, a program for performing processing concerning image formation, and a document storage for storing a stored document, comprising:
a document management service receiving from one apparatus connected via a network a certification information acquisition request for the stored document stored in said document storage, and transmitting to said one apparatus first certification information certifying a usage right on said document management service and second certification information certifying a usage right on the stored document according to said certification information acquisition request; while
receiving from another apparatus also connected via the network a stored document acquisition request with a utilization of said first certification information and said second certification information, acquiring the stored document according to said second certification information from said document storage, and transmitting it to said other apparatus.

52. An image forming apparatus comprising a hardware resource used for image formation, a program for performing processing concerning image formation, and a document storage for storing a stored document, comprising:
a document output service receiving from one apparatus connected via a network first certification information certifying a usage right on a document management service of another apparatus, and second certification information certifying a usage right on the stored document, and transmitting a stored document acquisition request with a utilization of said first and second certification information to said other apparatus, while
receiving the stored document according to said second certification information from the document management service of said other apparatus, and outputting said stored document.

53. An image forming apparatus comprising a hardware resource used for image formation, a program for performing processing concerning image formation, and a document storage for storing a stored document, comprising:
a document management service receiving from one apparatus connected via a network a certification information acquisition request for the stored document stored in said document storage, and transmitting to said one apparatus first certification information certifying a usage right on said document management service and second certification information certifying a usage right on the stored document according to said certification information acquisition request; while
receiving from another apparatus also connected via the network a stored document acquisition request with a utilization of said second certification information and third certification information providing the usage right on said document management service, acquiring the stored document according to said second certification information from said document storage, and transmitting the same to said other apparatus.

54. The image forming apparatus as claimed in claim 53, wherein:
said document management service creates contents of said first through third certification information, and transmits identification information of said first through third certification information to said one apparatus or said other apparatus, while holding the contents of said first through third certification information.

55. The image forming apparatus as claimed in claim 53, wherein:
upon receiving the stored document acquisition request with a utilization of said second and third certification information, said document management service determines contents of said second and third certification information by using identification information of said second and third certification information, while acquiring the stored document according to the contents of said second certification information, and transmitting the same to a document output service of said other apparatus.

56. The image forming apparatus as claimed in claim 53, wherein:
said certification information acquisition request at least comprises identification information for identifying the stored document and certification information certifying a usage right on the stored document.

57. The image forming apparatus as claimed in claim 53, wherein:
said first certification information comprises identification information for a session established between said one apparatus and said document management service, while said third certification information comprises identification information for a session established between said other apparatus and said document management service.

58. The image forming apparatus as claimed in claim 53, wherein:
said one apparatus comprises one of a network apparatus and another image forming apparatus.

59. The image forming apparatus as claimed in claim 53, wherein:
said other apparatus comprises another image forming apparatus.

60. An image forming apparatus comprising a hardware resource used for image formation, a program for performing processing concerning image formation, and a document storage for storing a stored document, comprising:
a document management service receiving from one apparatus connected via a network a first certification information certifying a usage right on a document output service and second certification information certifying a usage right on said stored document, and transmitting to another apparatus a stored document acquisition request with a utilization of said second certification information and third certification information certifying a usage right on a document management service of said other apparatus, while
receiving the stored document according to said second certification information from the document management service of said other apparatus, and outputting said stored document.

61. The image forming apparatus as claimed in claim 60, wherein:
said document management service creates contents and identification information of said third certification information, and transmits the identification information for said third certification information to said other apparatus, while holding the contents of said third certification information.

62. The image forming apparatus as claimed in claim 60, wherein:
said first certification information comprises identification information for a session established between said one apparatus and said document output service, while said third certification information comprises identification information for a session established between said other apparatus and said document output service.

63. The image forming apparatus as claimed in claim 60, wherein:
said one apparatus comprises one of a network apparatus and another image forming apparatus.

64. The image forming apparatus as claimed in claim 60, wherein:
said other apparatus comprises another image forming apparatus.

65. A stored document output method for an image forming apparatus comprising a hardware resource used for image formation, a program for performing processing concerning image formation, and a document storage for storing a stored document, said method comprising the steps of:
a) receiving a certification information acquisition request for the stored document stored in said document storage from one apparatus via a network;
b) transmitting certification information in response to the certification information acquisition request to said one apparatus;
c) receiving from another apparatus also connected via the network a stored document acquisition request with a utilization of said certification information; and
d) transmitting the stored document according to said certification information to said other apparatus.

66. A stored document output method for an image forming apparatus comprising a hardware resource used for image formation, a program for performing processing concerning image formation, and a document storage for storing a stored document, said method comprising the steps of:
a) receiving certification information for the stored document stored in another apparatus, from one apparatus, both connected via a network;
b) transmitting a stored document acquisition request with a utilization of said certification information to said other apparatus;
c) receiving the stored document according to said certification information from said other apparatus; and
d) outputting the stored document.

67. A stored document output method for an image forming apparatus comprising a hardware resource used for image formation, a program for performing processing concerning image formation, and a document storage for storing a stored document, said method comprising the steps of:
a) receiving from one apparatus connected via a network a certification information acquisition request for the stored document stored in said document storage;
b) transmitting to said one apparatus first certification information certifying a usage right on a document management service and second certification information certifying a usage right on the stored document in response to said certification information acquisition request;
c) receiving from another apparatus also connected via the network a stored document acquisition request with a utilization of said first certification information and said second certification information; and
d) acquiring the stored document according to said second certification information from said document storage, and transmitting the same to said other apparatus.

68. A stored document output method for an image forming apparatus comprising a hardware resource used for image formation, a program for performing processing concerning image formation, and a document storage for storing a stored document, said method comprising the steps of:
a) receiving from one apparatus connected via a network first certification information certifying a usage right on a document management service of another apparatus, and second certification information certifying a usage right on said stored document;
b) transmitting a stored document acquisition request with a utilization of said first and second certification information to said other apparatus;
c) receiving the stored document according to said second certification information from the document management service of said other apparatus; and
d) outputting said stored document thus received.

69. A stored document output method for an image forming apparatus comprising a hardware resource used for image formation, a program for performing processing concerning image formation, and a document storage for storing a stored document, said method comprising the steps of:
a) receiving from one apparatus connected via a network a certification information acquisition request for the stored document stored in said document storage;
b) transmitting to said one apparatus first certification information certifying a usage right on a document management service and second certification information certifying a usage right on the stored document in response to said certification information acquisition request;
c) receiving from another apparatus also connected via the network a stored document acquisition request with a utilization of said second certification information and third certification information providing the usage right on said document management service; and
d) acquiring the stored document according to said second certification information from said document storage, and transmitting the same to said other apparatus.

70. A stored document output method for an image forming apparatus comprising a hardware resource used for image formation, a program for performing processing concerning image formation, and a document storage for storing a stored document, said method comprising the steps of:
a) receiving from one apparatus connected via a network first certification information certifying a usage right on a document output service and second certification information certifying a usage right on said stored document;
b) transmitting to another apparatus a stored document acquisition request with a utilization of said second certification information and third certification information certifying a usage right on a document management service of said other apparatus;
c) receiving the stored document according to said second certification information from the document management service of said other apparatus; and
d) outputting said stored document thus received.

71. A stored document output system using at least one apparatus connected to a network and an image forming apparatus connected to said one apparatus via the network, and outputting a stored document stored in a document storage of said image forming apparatus, said image forming apparatus comprising:
a document management service receiving a certification information acquisition request for the stored document stored in said document storage from one apparatus via the network, and providing certification information in response to the certification information acquisition request, to said one apparatus; while
receiving from another apparatus also connected via the network a stored document acquisition request with a utilization of said certification information, and transmitting the stored document according to said certification information to said other apparatus.

72. A stored document output system using at least one apparatus connected to a network and an image forming apparatus connected to said one apparatus via the network, and outputting a stored document stored in a document storage of said image forming apparatus, said image forming apparatus comprising:
a document output service receiving certification information for the stored document stored in another apparatus, from one apparatus, both connected via the network, and transmitting a stored document acquisition request with a utilization of said certification information, to said other apparatus, while:
upon receiving the stored document according to said certification information from said other apparatus, said document output service outputting the stored document.

73. A stored document output system using at least one apparatus connected to a network and an image forming apparatus connected to said one apparatus via the network, and outputting a stored document stored in a document storage of said image forming apparatus, said image forming apparatus comprising:
a document management service receiving from one apparatus connected via a network a certification information acquisition request for the stored document stored in said document storage, and transmitting to said one apparatus first certification information certifying a usage right on said document management service and second certification information certifying a usage right on the stored document in response to said certification information acquisition request; while
receiving from another apparatus also connected via the network a stored document acquisition request with a utilization of said first certification information and said second certification information, acquiring the stored document according to said second certification information from said document storage, and transmitting it to said other apparatus.

74. A stored document output system using at least one apparatus connected to a network and an image forming apparatus connected to said one apparatus via the network, and outputting a stored document stored in a document storage of said image forming apparatus, said image forming apparatus comprising:
a document output service receiving from one apparatus connected via the network first certification information certifying a usage right on a document management service of another apparatus, and second certification information certifying a usage right on said stored document, and transmitting a stored document acquisition request with a utilization of said first and second certification information to said other apparatus, while
receiving the stored document according to said second certification information from the document management service of said other apparatus, and outputting said stored document.

75. A stored document output system using at least one apparatus-connected to a network and an image forming apparatus connected to said one apparatus via the network, and outputting a stored document stored in a document storage of said image forming apparatus, said image forming apparatus comprising:
a document management service receiving from one apparatus connected via the network a certification information acquisition request for the stored document stored in said document storage, and transmitting to said one apparatus first certification information certifying a usage right on said document management service and second certification information certifying a usage right on the stored document according to said certification information acquisition request; while
receiving from another apparatus also connected via the network a stored document acquisition request with a utilization of said second certification information and third certification information providing the usage right on said document management service, acquiring the stored document according to said second certification information from said document storage, and transmitting the same to said other apparatus.

76. A stored document output system using at least one apparatus connected to a network and an image forming apparatus connected to said one apparatus via the network, and outputting a stored document stored in a document storage of said image forming apparatus, said image forming apparatus comprising:
a document management service receiving from one apparatus connected via the network first certification information certifying a usage right on a document output service and second certification information certifying a usage right on said stored document, and transmitting to another apparatus a stored document acquisition request with a utilization of said second certification information and third certification information certifying a usage right on a document management service of said other apparatus, while
receiving the stored document according to said second certification information from the document management service of said other apparatus, and outputting said stored document.
